(19) United States
(12) Patent Application Publication
(10) Pub. No.: US 2023/0033494 A1
(43) Pub. Date: Feb. 2, 2023

(54) DEPOSITION OF ALUMINUM 5XXX ALLOY USING LASER ENGINEERED NET SHAPING

(71) Applicants: THE REGENTS OF THE UNIVERSITY OF CALIFORNIA, Oakland, CA (US); RAMOT AT TEL-AVIV UNIVERSITY LTD., Tel-Aviv (IL)

(72) Inventors: Noam Eliaz, Tel-Aviv (IL); David Svetlizky, Tel-Aviv (IL); Julie Schoenung, Oakland, CA (US); Enrique J. Lavernia, Oakland, CA (US); Yizhang Zhou, Oakland, CA (US); Baolong Zheng, Oakland, CA (US)

(73) Assignees: THE REGENTS OF THE UNIVERSITY OF CALIFORNIA, Oakland, CA (US); RAMOT AT TEL-AVIV UNIVERSITY LTD., Tel-Aviv (IL)

(21) Appl. No.: 17/785,904

(22) PCT Filed: Dec. 16, 2020
(86) PCT No.: PCT/US2020/065373

§ 371 Date: Jun. 15, 2022

Related U.S. Application Data
(60) Provisional application No. 62/948,354, filed on Dec. 16, 2019.

(51) Int. Cl. B22F 10/25; C22C 21/06; B33Y 70/00; B33Y 10/00; B33Y 50/02

(52) U.S. Cl. CPC B22F 10/25; C22C 21/06; B33Y 70/00; B33Y 10/00; B33Y 50/02; B22F 2301/052; B22F 2304/10

(57) ABSTRACT

A method for forming a 2-dimensional pattern or 3-dimensional object using an aluminum (Al) 5xxx series alloy includes providing a feedstock that includes the Al 5xxx alloy. The method further includes depositing, using an additive manufacturing process, the feedstock under thermal conditions that permit formation of the pattern or object. The method further includes adjusting a parameter of the additive manufacturing process during the depositing.

### CROSS-REFERENCE TO RELATED APPLICATIONS

This application claims the benefit and priority of U.S. Provisional Application No. 62/948,354, entitled “DEPOSITION OF AL 5XXX ALLOY USING LASER ENGINEERED NET SHAPING,” filed on Dec. 16, 2019, the entire disclosure of which is hereby incorporated by reference in its entirety.

### BACKGROUND

### 1. Field

The present disclosure is directed to systems and methods for deposition of aluminum 5xxx series using additive manufacturing technologies (including Direct Energy Deposition (DED) techniques such as Laser Engineered Net Shaping, LENS®) in such a way as to reduce or eliminate defects such as cracks and pores in the resulting object.

### 2. Description of the Related Art

Additive manufacturing (AM) offers many advantages over conventional methods for materials processing and manufacturing. The Laser Engineered Net Shaping (LENS®) process is an AM process and belongs to the branch of Directed Energy Deposition (DED) AM technologies. LENS® has been successfully used to process a variety of materials, including alloy steels, stainless steels, tool steels, nickel-base superalloys, cobalt-base alloys, intermetallics, titanium-base alloys, shape memory alloys (SMAs), magnetic materials, high-entropy alloys, refractory metals, ceramics, cermets, composites, functionally gradient materials (FGMs), and metallic glasses. Some of these materials were processed with desirable physical and/or mechanical properties.

### SUMMARY

Described herein is a method for forming a 2-dimensional pattern or 3-dimensional object using an aluminum (Al) 5xxx series alloy. The method includes providing a feedstock that includes the Al 5xxx alloy. The method further includes depositing, using an additive manufacturing process, the feedstock under thermal conditions that permit formation of the pattern or object. The method further includes adjusting a parameter of the additive manufacturing process during the depositing.

Also disclosed is a method for forming a 2-dimensional pattern or 3-dimensional object using an aluminum (Al) 5xxx series alloy. The method includes providing a feedstock that includes the Al 5xxx alloy. The method further includes depositing, using an additive manufacturing process, the feedstock under thermal conditions that permit formation of the pattern or object, the additive manufacturing process having adjustable parameters that include at least one of a laser power, a scan speed, a mass flow rate, a hatch spacing, a Z spacing, or an oxygen concentration in a deposition chamber, and at least one of the adjustable parameters varying over time during the depositing the feedstock to facilitate formation of the pattern or object.

Also disclosed is a system for forming a 2-dimensional pattern or 3-dimensional object using an aluminum (Al) 5xxx series alloy. The system includes a feedstock that includes the Al 5xxx alloy. The system further includes an additive manufacturing machine designed to deposit and melt the feedstock at parameters that include a laser power, a scan speed, a mass flow rate, a hatch spacing, a Z spacing, and an oxygen concentration in a deposition chamber. At least one of the laser power, the scan speed, the mass flow rate, the hatch spacing, the Z spacing, or the oxygen concentration in the deposition chamber is designed to vary over time to facilitate formation of the pattern or object.

### BRIEF DESCRIPTION OF THE DRAWINGS

Other systems, methods, features, and advantages of the present invention will be or will become apparent to one of ordinary skill in the art upon examination of the following figures and detailed description. It is intended that all such additional systems, methods, features, and advantages be included within this description, be within the scope of the present invention, and be protected by the accompanying claims. Component parts shown in the drawings are not necessarily to scale, and may be exaggerated to better illustrate the important features of the present invention. In the drawings, like reference numerals designate like parts throughout the different views, wherein:

FIG. 1 is a block diagram illustrating an exemplary system for forming a 2D or 3D pattern or object using additive manufacturing (AM) of an AL 5xxx alloy, in accordance with various embodiments of the present disclosure;

FIG. 2 is a flowchart illustrating a method for forming a 2D or 3D pattern or object using additive manufacturing (AM) of an Al 5xxx alloy, in accordance with various embodiments of the present disclosure;

FIG. 3 illustrates SEM images of an AL 5083 powder showing a shape and surface morphology and a cross-section thereof, in accordance with various embodiments of the present disclosure;

FIGS. 4A and 4B are graphs illustrating particle size distribution and sphericity distribution of gas-atomized Al 5083 powder, in accordance with various embodiments of the present disclosure;

FIG. 5A is a schematic drawing illustrating an object formed using the method of FIG. 2, in accordance with various embodiments of the present disclosure;

FIG. 5B illustrates tensile test dimensions of the object of FIG. 5A, in accordance with various embodiments of the present disclosure;

FIG. 6A illustrates SEM images of pores in a cross-section of an object formed using the method of FIG. 2, in accordance with various embodiments of the present disclosure;

FIG. 6B illustrates an EDS line-scan across a left, spherical pore of FIG. 6A, in accordance with various embodiments of the present disclosure;

FIGS. 7A and 7B are plots illustrating the effect of various powder mass flow rates and laser scan speeds on the relative density of a printed AL, alloy, in accordance with various embodiments of the present disclosure;

FIG. 8 shows various images illustrating μ-CT spatial reconstruction images of a sample object formed using the method of FIG. 2, in accordance with various embodiments of the present disclosure;

FIGS. 9A and 9B show plots illustrating various pore diameter histograms and cumulative distributions based on a μ-CT analysis, in accordance with various embodiments of the present disclosure;

FIGS. 10A and 10B show plots illustrating various pore sphericity histograms and cumulative distributions based on a μ-CT analysis, in accordance with various embodiments of the present disclosure;

FIG. 11 is a plot showing a comparison between mean relative densities of Al 5xxx printed samples obtained using an Archimedes technique and a μ-CT technique, in accordance with various embodiments of the present disclosure;

FIG. 12 shows light microscope composition images of a cross-section of a sample object formed using the method of FIG. 2, in accordance with various embodiments of the present disclosure;

FIGS. 13A and 13B show a SEM secondary electron image of a randomly selected area in a sample object formed using the method of FIG. 2, an EBSD orientation map thereof, pole figures, grain side distribution of the sample, and grain aspect ratio distribution of the sample, in accordance with various embodiments of the present disclosure;

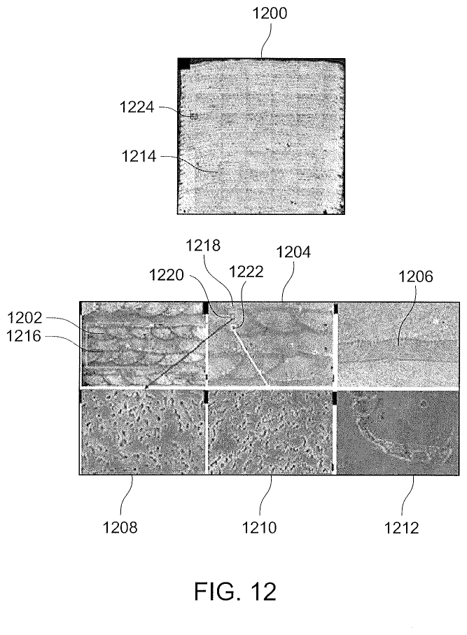

FIG. 12 is a graph illustrating XRD patterns of an as-deposited Al alloy, a gas-atomized Al 5083 powder, and wrought Al 5083-0, in accordance with various embodiments of the present disclosure;

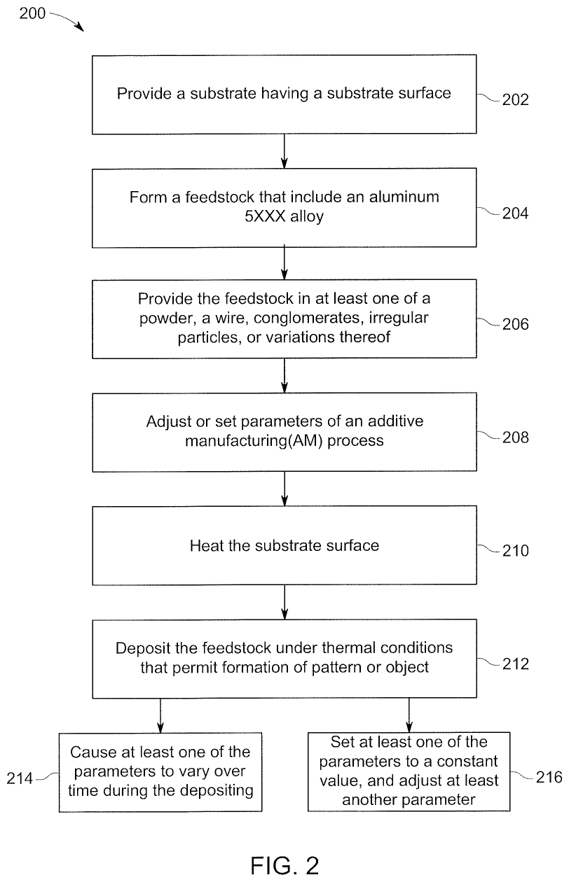

FIGS. 15A, 15B, and 15C are plots illustrating Vickers microhardness measurements of an as-deposited sample object formed using the method of FIG. 2, in accordance with various embodiments of the present disclosure;

FIG. 16A is a graph illustrating an engineering stress-strain curve of an as-deposited sample object formed using the method of FIG. 2, in accordance with various embodiments of the present disclosure;

FIG. 16B is a graph illustrating a representative stress-strain curve from FIG. 16A, in accordance with various embodiments of the present disclosure;

FIG. 16C shows drawings illustrating DIC longitudinal strain-contour images corresponding to numbered points along the stress-strain curve of FIG. 16B, in accordance with various embodiments of the present disclosure; and

FIG. 17 shows drawings illustrating SEM-SE images of fracture surfaces after tension tests, in accordance with various embodiments of the present disclosure.

### DETAILED DESCRIPTION

Despite the success attained with various alloys, processing of other materials such as high-quality structural aluminum alloys remains a challenge. This challenge is related mainly to the inherent properties of aluminum, its alloys, and its raw powder (or other form) feedstock: (1) Aluminum (Al) is characterized by high laser reflectivity and high thermal conductivity. The high laser reflectivity and thermal conductivity of aluminum results in at least one of crack initiation due to a higher cooling rate or formation of metallurgical defects such as pores and cracks due to less heat accumulation during processing. (2) Increased laser energy may promote selective evaporation of elements in the aluminum alloy that have a low boiling point such as zinc (Zn) and magnesium (Mg). This evaporation potentially results in gas porosity in the deposited aluminum alloy and degradation of mechanical properties of the resulting object. In addition, fluctuation in alloy composition and hot cracking may occur relatively easily during laser cycling. (3) The high thermal expansion coefficient and wide solidification temperature range of aluminum may generate a large amount of residual stress during rapid solidification, which causes the parts to crack and deform. (4) Poor powder flowability due to the low density of the Al powder along with low viscosity of molten Al also raises difficulty in AM of aluminum alloys. This may cause unstable powder flow into the melt pool and result in unstable deposition and subsequent porosity. (5) Moisture absorption in Al powders is high. Since the solubility of hydrogen in molten Al is more than 19 times higher than in solid Al, hydrogen-related porosity may form when the melt solidifies rapidly, thereby degrading performance. (6) Al is highly susceptible to oxidation. The native oxide on the raw powder feedstock has high melting temperature (e.g., 3,751 degrees Fahrenheit (F) (2,066 degrees Celsius (C))), may reduce the melt-pool wettability, cause oxide inclusions in the as-deposited material, and promote porosity. Therefore, strict requirements exist for oxygen partial pressure (or vacuum) of the processing environment.

All of the aforementioned factors play a significant role in hindering the development of adequate Al-base alloys using either PBF or DED technology. To date, only few aluminum alloys have been printed with sufficiently high quality, the most common ones being aluminum-silicon (AlSi) alloys and aluminum-silicon-magnesium (AlSiMg) alloys. The main reason for the popularity and the extensive study of these alloys is the high Si content, which increases the wettability properties of the melt pool and decreases the shrinkage.

AM of non-heat-treatable aluminum alloys in general, and AlMg alloys specifically, has seen limited success. No 3D printing of Al 5754 by any 3D printing technology has proven to be successful. The present disclosure provides a process for depositing or 3D printing Al alloys, mainly those containing also Mg.

It is the purpose of the present disclosure to provide a directed energy deposition (DED) of Al 5xxx AlMg alloy by the Laser Engineered Net Shaping (LENS®) process. As explained above, Laser Engineered Net Shaping (LENS®) belongs to the branch of DED AM technologies. LENS® has been successfully used to process a variety of materials, including alloy steels, stainless steels, tool steels, nickel-base superalloys, cobalt-base alloys, intermetallics, titanium-base alloys, shape memory alloys (SMAs), magnetic materials, high-entropy alloys, refractory metals, ceramics, cermets, composites, functionally gradient materials (FGMs), metallic glasses and even aluminum-base materials. In the LENS® process, computer-controlled lasers weld air-blown streams of metallic powders into custom parts and manufacturing molds. The technique produces shapes that may be used, at times with very little manipulation, as the final products. These may be of any shape and size.

More specifically, in a LENS® device, nozzles direct a stream of metal powder at a substrate and the metal powder is simultaneously heated by a high-power laser beam. The laser and nozzles may remain stationary while the substrate is moved to provide new targets on the substrate on which the metal powder is deposited. For the construction of 3-dimensional (3D) objects, deposition is first done on a substrate and then on any layer or pattern of at least one of the molten or solidified metal that forms on the substrate until the 3D shape or pattern is obtained.

In a first aspect of the present disclosure, a method is provided for forming an Al 5xxx alloy into a 2-dimensional pattern or 3-dimensional object. The method includes streaming an Al 5xxx powder onto a (laser-heated) substrate under conditions permitting formation of the pattern or object.

As known in the art, aluminum alloys are categorized into a number of groups based on particular characteristics of the material such as its ability to respond to thermal and mechanical treatment and to the primary alloying element added to the aluminum alloy. Al alloys of the 4-digit system xxxx refer to the wrought system. The first digit (Xxxx) indicates the principal alloying element, which has been added to the aluminum alloy and is often used to describe the aluminum alloy series. The second single digit (xXxx), if different from 0, indicates a modification of the specific alloy, and the third and fourth digits (xxXX) are arbitrary numbers given to identify a specific alloy in the series. Accordingly, the “Al 5xxx alloys” are a family of wrought aluminum alloys where the principal alloying element is magnesium. The Al 5xxx Alloys are typically aluminum/magnesium alloys, wherein the amount of magnesium is typically between 0.1 percent (0.11%) and 10%, between 0.5% and 8%, between 1% and 6%, or the like. For example, 5xxx Al—Mg includes between 1% and 2.5% of Mg, and 5xxx aluminum-magnesium-manganese (Al—Mg—Mn) includes between 3% and 6% of Mg. The alloy types and their chemical compositions are contained in the Aluminum Association's Textbook entitled “International Alloy Designations and Chemical Composition Limits for Wrought Aluminum and Wrought Aluminum Alloys” and in the Aluminum Association's Pink Book entitled “Designations and Chemical Composition Limits for Aluminum Alloys in the Form of Castings and Ingot.”

The various aluminum alloys in the 5xxx series include, for example, Al alloys: 5005 (99.2% by weight of Al (99.2% Al), 0.8% Mg), 5010 (99.3% Al, 0.5% Mg, 0.2% Mn), 5019 (94.7% Al, 5.0% Mg, 0.25% Mn), 5024 (94.5% Al, 4.6% Mg, 0.6% Mn, 0.1% zirconium (Zr), 0.2% scandium (Sc)), 5026 (93.9% Al, 4.5% Mg, 1.0% Mn, 0.9% silicon (Si), 0.4% iron (Fe), 0.3% copper (Cu)), 5050 (98.6% Al, 1.4% Mg), 5052 (97.2% Al, 2.5% Mg, 0.25% chromium (Cr)), 5056 (94.8% Al, 5.0% Mg, 0.12% Mn, 0.12% Cr), 5059 (93.5% Al, 5.0% Mg, 0.8% Mn, 0.6% Zn, 0.12% Zr), 5083 (94.8% Al, 4.4% Mg, 0.7% Mn, 0.15% Cr), 5086 (95.4% Al, 4.0% Mg, 0.15% Cr), 5154 (96.2% Al, 3.5% Mg, 0.25% Cr), 5182 (95.2% Al, 4.5% Mg, 0.35% Mn), 5252 (97.5% Al, 2.5% Mg), 5254 (96.2% Al, 3.5% Mg, 0.25% Cr), 5356 (94.6% Al, 5.0% Mg, 0.12% Cr, 0.12% Mn, 0.13% titanium (Ti)), 5454 (96.4% Al, 2.7% Mg, 0.12% Cr, 0.8% Mn), 5456 (94.0% Al, 5.1% Mg, 0.12% Cr, 0.8% Mn), 5457 (98.7% Al, 1.0% Mg, 0.1% Cu, 0.2% Mn), 5557 (99.1% Al, 0.6% Mg, 0.1% Cu, 0.2% Mn), 5652 (97.2% Al, 2.5% Mg, 0.25% Cr), 5657 (99.2% Al, 0.8% Mg), 5754 (95.8% Al, 3.1% Mg, 0.3% Cr, 0.5% Mn), and others.

The Al 5xxx used in accordance with the present disclosure may include any one or more of the above, or any one or more additional known or unknown Al 5xxx alloys. In some embodiments, the Al alloy includes Al 5754.

In some embodiments, the Al alloy may be further enriched with elements different from Mg, Cr, Mn and Cu. Such additional elements may include, for example, at least one of scandium (Sc), zirconium (Zr), erbium (Er), nickel (Ni), zinc (Zn), hafnium (Hf), lithium (Li), yttrium (Y), gadolinium (Gd), titanium (Ti), niobium (Nb), or oxygen (O), or others. Addition of these elements to the Al 5xxx alloy may result in processing of heat-treatable alloys with enhanced mechanical properties.

The powder shape, morphology, and density of the Al 5xxx alloy may be dependent on the manufacturing process of the powder. In some embodiments, the Al 5xxx alloy is provided in a particulate form, e.g., produced by a gas atomization process. The particulate form may be of a particle size specifically selected based on the alloy used, the processing conditions used, the object to be formed, and other considerations. In some embodiments, the particulate form may have a particle diameter size that is 200 micrometers (200 μm, 0.00787 inches) or less, such as between 1 μm and 200 μm (between 0.0000394 inches and 0.00787 inches), between 10 μm and 175 μm (0.000394 inches and 0.00689 inches), between 25 μm and 150 μm (0.000984 inches and 0.00591 inches), or the like. The particles used may be spherical in shape in order to allow stable or constant mass flow of the powder through the nozzle.

In a method of the present disclosure, 2-dimensional (2D) patterns or 3D objects may be formed by streaming an Al 5xxx alloy, in the form of a powder, onto a substrate, which may optionally be heated, under conditions that bring about the formation of the patterns or objects. The “conditions that bring about the formation of the pattern or object” may be varied to provide patterns and objects having different characteristics. The processing parameters and conditions, such as powder mass flow rate, laser scan speed, laser power, Z-spacing, hatch spacing, and oxygen concentration in the deposition chamber, may have an effect on the chemical composition, density, surface roughness, and mechanical properties of the deposited material. Generally speaking, to deposit Al 5xxx alloys, high laser power (e.g., 5 kilowatts (5 kW) or less such as between 100 W and 5 kW, between 200 W and 3 kW, between 400 W and 900 W, or about 800 W; where utilized in this context, “about” refers to the referenced value plus or minus 10% of the referenced value) may be utilized in the early deposition stage. In response to the temperature in the deposited materials and/or substrate begins to increase, a reduced laser power (e.g., between 50 W and 1 kW, between 100 W and 800 W, between 100 W and 500 W, or the like) may be utilized to avoid relatively high laser back reflection from deposited Al.

In some embodiments, the conditions permitting formation of the pattern or object include laser power, scan speed, mass flow rate, hatch spacing, Z spacing, and/or oxygen concentration in the deposition chamber. In some embodiments, the conditions involve laser power and scan speed. In some embodiments, the processing conditions/parameters used for deposition of Al 5xxx alloys according to a process of the invention include any one or more of the following: a laser power of less than 5 kW, a scan speed of 100 millimeters per second (mm/s, 3.94 inches/s) or less (e.g., between 11 nm/s and 100 mm/s (0.0394 inches/s and 3.94 inches/s), between 10 mm/s and 80 mm/s (0.394 inches/s and 3.15 inches/s), between 20 mm/s and 70 mm/s (0.787 inches/s and 2.76 inches/s), between 11 mm/s and 25 mm/s (0.433 inches/s and 0.984 inches/s), or the like), and a mass flow rate of 150 grams per minute (g/m, 5.29 ounces per minute (oz/m)) or less (e.g., between 0.1 g/m and 150 g/m (0.0353 oz/m and 5.29 oz/m), between 1 g/m and 100 g/m (0.353 oz/m and 3.53 oz/m), between 5 g/m and 33 g/min (0.176 oz/m and 1.16 oz/m), or the like). In some embodiments, the conditions are selected to allow a hatch spacing of between 0.01 mm and 1 mm, between 0.1 mm and 0.8 mm, 0.2 mm and 0.6 mm, or the like. In some embodiments, the conditions are selected to allow a Z spacing of between 0.01 mm and 1 mm, between 0.1 mm and 0.5 mm, between 0.2 mm and 0.3 mm, or the like.

As may be understood, the relationships of mutual influence and mutual restriction exist among the above conditions/parameters for proper processing control. Both laser power and scan speed play a significant role in built-up processing. Since Al alloy powder inherently has a relatively high thermal conductivity and a relatively high laser reflectivity, relatively high laser power may be needed in the early stage of deposition, as described above. On the other hand, a heated substrate may be beneficial in the initial stage deposition. For heated substrates, a defocused laser beam with relatively low laser power may be used in order to avoid melting of the substrate. In such cases, the conditions of use may involve a defocus distance of about 50 mm, a laser power of about 200 W, and a laser scan speed of about 12 mm/s. In some embodiments, the region to be deposited may be scanned repeatedly until the substrate surface temperature reaches a desired value, e.g., 400 degrees C. (751 degrees F.).

In some embodiments, the method of the present disclosure includes streaming an Al 5xxx alloy, as defined, in the form of a metal powder or other feedstock at a substrate that is optionally heated, at a mass flow rate of between 5 and 33 g/min; directing a laser having a power of between 400 W and 900 W at said powder (while at least one of the laser source and the powder stream source remain stationary and the substrate is moved, or while the substrate is stationary and the laser and powder sources are moved), at a scan speed of between 11 and 25 mm/s, to provide new targets on which the metal powder can deposit.

The disclosure further provides a method for forming an Al 5xxx alloy into a 2-dimensional pattern or 3-dimensional object. The method includes streaming an Al 5xxx powder onto a substrate under thermal conditions, where at least one parameter (e.g., at least one of a laser power, a scan speed, or a mass flow rate) is preselected and the remaining of said parameters are appropriately adjusted, to thereby form the pattern or object.

Patterns and objects formed by methods of the present disclosure may be substantially 2-dimensional, namely having a minimal thickness, such as welding patterns, or 3- dimensional. The patterns and objects may be used in a variety of industries, such as the automobile industry, the aircraft industry, the fishing industry, or the like. Thus, objects may be of any size and shape and may be utilized in one or more of shipbuilding, automobile manufacturing (in the form of sheets, vehicle frames, seals, or the like), buses, railway and underground wagons, food processing equipment, welded chemical and nuclear structures, storage tanks, boiler-making, recipients for petrol, architecture and interior design, fishing industry equipment, tread plates, refrigerators, beverage cans, or the like.

A wide variety of patterns or objects, e.g., microstructures, may be achieved with processes of the invention. While mechanical property tests indicate the deposited Al 5xxx alloys were equivalent to materials fabricated via traditional manufacturing processes such as cast and wrought, Al 5xxx alloys could be used for Al 5xxx component repair and rapid manufacturing in which conventional methods may be undesirable.

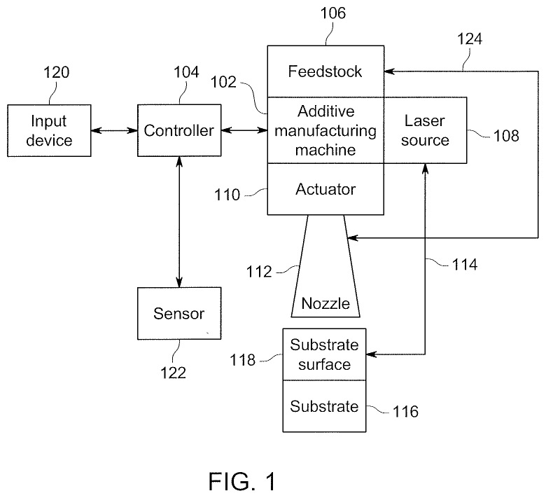

Referring to FIG. 1, an exemplary system 100 for forming a 2D or 3D pattern or object using additive manufacturing (AM) of an AL 5xxx alloy is shown. The system 100 may include an additive manufacturing machine or system 102. Any additive manufacturing machine 102 may include any commercially available or proprietary additive manufacturing machine (e.g., 3D printer) that receives a feedstock 106, has a nozzle 112 that deposits a known quantity of the feedstock 106, and a heat source (e.g., a laser source 108) that heats the deposited or pre-deposited feedstock 106 to melt the feedstock 106. In some embodiments, the deposition may be performed in a controlled environment chamber (e.g., a “glovebox type” additive manufacturing machine).

The system 100 may further include a controller 104. The controller 104 may include a logic device such as one or more of a central processing unit (CPU), an accelerated processing unit (APU), a digital signal processor (DSP), a field programmable gate array (FPGA), an application specific integrated circuit (ASIC), or any other device capable of implementing logic. In some embodiments, the controller 104 may further include any non-transitory memory known in the art. The memory may store instructions usable by the logic device to perform operations as described herein.

The controller 104 may control various aspects of the system 100. For example, the controller 104 may control one or more parameter of the additive manufacturing process such as a laser power of the laser source 108, a scan speed of the additive manufacturing machine 102, a mass flow rate of the feedstock 106 through the nozzle 112, a target direction of the laser source 108, a location of the nozzle 112 relative to a substrate 116 or other surface, or the like. In some embodiments, the controller 104 may be programmed to control the parameters based on various factors such as an elapsed time since initiation of each additive manufacturing process, a programmed periodic adjustment to one or more parameter, a temperature of the molted or solidified feedstock 106, known parameter values, or the like.

In some embodiments, the system 100 may further include an input device 120. The input device 120 may receive input from an operator of the system 100 such as an adjustment to a parameter of the additive manufacturing process, a preselected parameter of the additive manufacturing process, a design of an object to be formed using the system 100, or the like. In some embodiments, the controller 104 may further adjust the parameters of the additive manufacturing process based on input received by the input device 120.

The system 100 may also include the feedstock 106. The feedstock may include an Al 5xxx alloy material, as described above. The feedstock 106 may be provided in any form such as a wire, a powder, conglomerates, irregular particles, or any variation or combination thereof. In some embodiments, the system 100 may further include equipment for forming the feedstock 106. For example, the system 100 may include equipment for forming the feedstock 106 using any of a gas atomization process, milling, grinding, machining, blending, water atomization, air atomization, a chemical process, or a physical process.

The system 100 may further include the laser source 108. The laser source 108 may include any laser source capable of at least one of generating or outputting a laser 114. In some embodiments, the laser source 108 may be capable of generating or outputting the laser 114 at a variable power. For example, the laser source 108 may be capable of generating or outputting a laser beam having a power of between 100 W and 5 kW.

The system 100 may also include an actuator 110. The actuator 110 may be coupled to the nozzle 112 and may actuate the nozzle 112 relative to the substrate 116 or other surface. In that regard, the nozzle 112 may deposit the feedstock 106 at a desired location on the substrate 116 or other surface based on a desired location of deposition of the feedstock 106.

The system 100 may further include the nozzle 112. As referenced above, the nozzle 112 may be actuated by the actuator 110 to adjust a location of deposition of the feedstock 106. The nozzle 112 may deposit the feedstock 106 at a desired location, desired mass flow rate, or the like based on instructions received from the controller 104.

The system 100 may further include a delivery system 124. The delivery system 124 may provide the feedstock 106 to the nozzle 112. In some embodiments, the delivery system 124 may control the rate of delivery of the feedstock 106 to the nozzle 112. In some embodiments, the rate of delivery may also or instead be controlled by the nozzle 112. In some embodiments, the delivery system 124 may constantly deliver the feedstock 106 to the nozzle 112 to ensure the feedstock 106 is constantly delivered.

In some embodiments, some elements or components of the system 100 may be subsystems of the additive manufacturing machine 102. In that regard, such elements or components may be integral with, removably coupled to, provided with, or provided separately from, the additive manufacturing machine 102. These elements or components may include any one or more of the controller 104, the feedstock 106, the laser source 108, the actuator 110, the nozzle 112, the substrate 116 (including the substrate surface 118), the input device 120, the sensor 122, or the system 124.

In some embodiments, the system 100 may be partially or wholly located in a deposition chamber. In some embodiments, the deposition chamber may be a glovebox-type deposition chamber.

The system 100 may also include a substrate 116 having a substrate surface 118. The substrate surface 118 may have a greater melting temperature than the feedstock 106 such that the laser source 108 may melt or partially melt the feedstock 106 on the substrate surface 118 without melting or harming the substrate surface 118. In addition, the substrate surface 118 may be formed from a material with which the Al 5xxx feedstock 106 is unlikely to bond. In that regard, when the 2D or 3D object is formed, it may be removed from the substrate surface 118 with relative ease (e.g., using electron discharge machining (EDM) or any other known means). In some embodiments, the substrate 116 may include a heater and the substrate surface 118 may be heated (either pre-heated or heated in-situ) prior to, or during, the additive manufacturing process. Such heating may reduce the likelihood of melting of the substrate surface 118, may reduce the likelihood of bonding of the deposited feedstock 106 to the substrate surface 118, may increase a temperature of the deposited feedstock 106 such that a lower power laser 114 may still melt the feedstock 106, or the like.

Although the system 100 is shown having a specific configuration, the present disclosure is equally applicable to additive manufacturing systems having any other configuration. For example, the disclosure may be applicable to additive manufacturing systems in which a substrate moves relative to nozzles. As another example, a system may include two, three, or more actuators to allow movement of a nozzle in two, three, or more directions (e.g., along two or three axes). As yet another example, a laser system may move along a single axis (e.g., a Z-axis) and a substrate (or nozzle) may move along other axes (e.g., the X-axis and Y-axis). As yet another example, the nozzle 112 may include any nozzle having any geometry, may include a single nozzle or multiple nozzles, or the like.

In some embodiments, the system 100 may include one or more sensor 122. The sensor 122 may include any one or more sensor capable of detecting data corresponding to the system 100, the deposited feedstock 106, or the like. For example, the sensor 122 may include a temperature sensor capable of detecting a temperature of the substrate surface 118 or the deposited feedstock 106; a camera or other optical sensor capable of detecting data corresponding to a size, shape, or the like of the deposited feedstock 106; a thermal camera; a meltpool sensor; a speed sensor capable of detecting a speed of movement of the actuator 110 or nozzle 112; a sensor capable of detecting an intensity of the laser 114; a mass flow sensor capable of detecting a mass flow rate of the feedstock 106 through the nozzle 112; or the like.

In some embodiments, the controller 104 may adjust one or more parameter of the additive manufacturing process based on data detected by the sensor. For example, the controller 104 may adjust an intensity of the laser source 108 based on a temperature of the deposited feedstock 106. As another example, the controller 104 may adjust the position of the actuator 110 based on a size or shape of the deposited feedstock 106.

Referring now to FIG. 2, a method 200 for forming a 2D or 3D pattern or object using additive manufacturing of an AL 5xxx alloy is shown. The method 200 may be implemented, for example, using a system similar to the system 100 of FIG. 1. However, a method according to the present disclosure may include or exclude any one or more blocks of the method 200, and may include any additional blocks as discussed herein, without departing from the scope of the present disclosure.

Referring to FIGS. 1 and 2 and in block 202, a substrate (e.g., the substrate 116) may be provided. The substrate may further include a substrate surface (e.g., the substrate surface 118). As discussed above, the substrate surface may be heated. For example, the substrate surface may be pre-heated using a heating stage (e.g., a fluid-based heating stage, an electrical-based heating stage, or the like) prior to placing the substrate in the additive manufacturing chamber. As another example, the substrate surface may be heated in-situ using, for example, laser scanning or another heat source. In some embodiments, the method 200 may be performed without any heating of the substrate.

In block 204, a feedstock (e.g., the feedstock 106) may be formed or procured. The feedstock may be or may include an Al 5xxx alloy as described herein.

In block 206, the feedstock may be provided in at least one of a powder, wire, conglomerates, irregular particles, or combinations or variations thereof. The feedstock may be provided to an additive manufacturing machine in the selected form.

In block 208, at least one of a user or a controller may adjust or set parameters of the additive manufacturing machine. This setting or adjustment may be made before or during the additive manufacturing process. For example, one or more parameters may be adjusted to vary over time, one or more parameter may be set as a constant throughout the process, or the like. In some embodiments, block 208 may further include setting an oxygen level in the additive manufacturing chamber to a desired value prior to beginning deposition.

In block 210, the substrate surface may be heated. As described above, this may be performed at least one of prior to placing the substrate in the chamber or in-situ in the chamber. In some embodiments, the method 200 may be performed without any heating of the substrate surface.

In block 212, the feedstock may be deposited by the additive manufacturing machine (e.g., using a nozzle and an actuator) onto the substrate surface. In some embodiments, the feedstock may be deposited on pre-deposited feedstock or onto a surface (e.g., during repair of a component) other than the substrate surface. The feedstock may be deposited under thermal conditions that permit formation of the pattern or object.

In block 214, the controller or an operator may cause at least one of the parameters to vary over time during the depositing of the feedstock. For example, at least one of the laser power of the laser source, the scan speed of the additive manufacturing machine, the mass flow rate of the feedstock through the nozzle, the hatch spacing, the Z spacing, or the oxygen concentration in the deposition chamber may be adjusted to vary over time. The adjustment may be periodic or non-periodic. Such adjustment may permit formation of the pattern or object without significant likelihood of incursion of defects in the pattern or object.

In block 216, the controller or an operator may set at least one of the parameters to a constant value and may adjust at least one other parameter. For example, the adjustment may be based on detected data, may be based on an elapsed amount of time, or the like. Control of the parameters in this manner may permit formation of the pattern or object without significant likelihood of incursion of defects in the pattern or object. In some embodiments, both blocks 214 and 216 may be incorporated into the method 200 together.

Discussion will now turn to an exemplary implementation of the method 200 using the LENS® process. Specific details of the implementation and results will be discussed.

1. Materials and Methods

Powder Feedstock

A pre-alloyed Al 5083 powder was processed by TLS Technik GmbH & Co. (Bitterfeld-Wolfen, Germany), using a gas atomization (GA) process. For the LENS® process, a powder particle diameter size range of between 44 μm and 150 μm and of a sufficiently spherical morphology to allow stable powder mass flow rate are desirable. Powder feedstock characterization was performed to confirm the quality of the custom-made powders in terms of morphology, chemical composition, powder sphericity, and size distribution. The powder feedstock morphology and cross-section were studied using a scanning electron microscope (SEM, Quanta 200 FEG, FEI, USA) operated under vacuum of 70 Pascals (Pa) and a voltage ranging from 5 kilo-electron-Volt (keV) to 20 keV. Images were acquired with either an Everhart-Thornley secondary electron detector (ETD) or a solid-state backscattered electron detector (SSD).

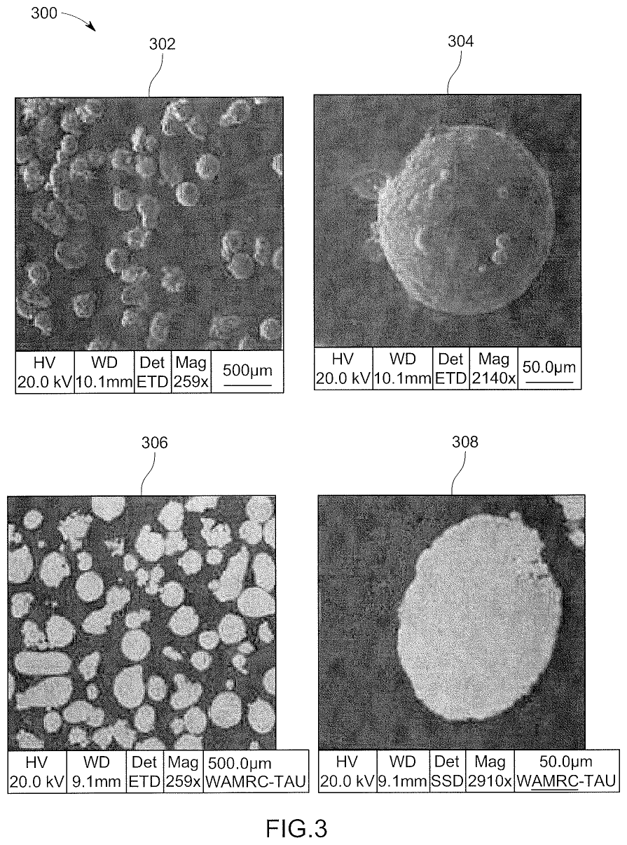

Referring to FIG. 3, SEM images of gas atomized Al 5083 powder are shown. Images 302, 304 illustrate the shape and surface morphology of particles of the powder, and images 306, 308 illustrate a cross-sectional view of the particles.

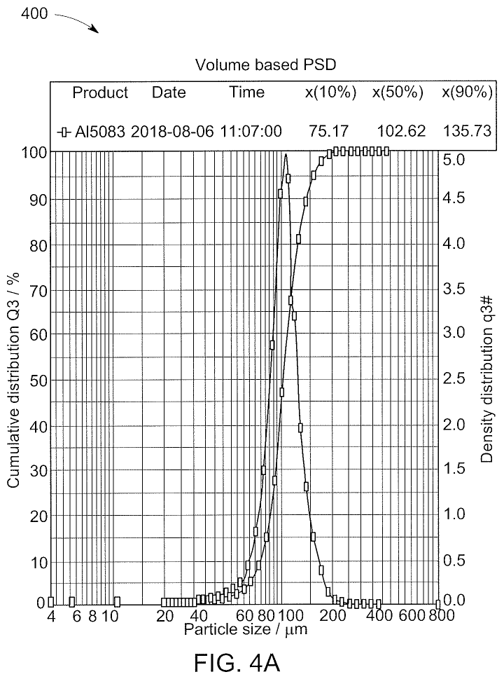

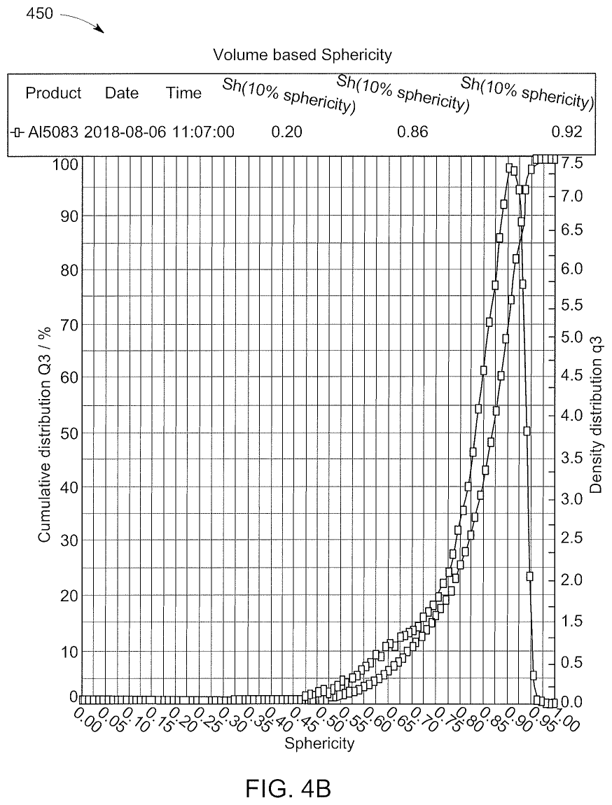

The particle size distribution (PSD) of the powder was measured using a QICPIC dynamic image analysis system (Sympatec GmbH, Clausthal-Zellerfeld, Germany). Referring to FIGS. 4A and 4B, particle size distribution and sphericity distribution of the gas-atomized Al 5083 feedstock powder are shown. In particular, the particle size distribution is shown by a graph 400 of FIG. 4A, and the sphericity distribution is shown by a graph 450 of FIG. 4B. The particle size distribution and sphericity distribution were measured using dynamic image analysis.

The chemical composition of the powder feedstock was analyzed by inductively coupled plasma optical emission spectrometry (ICP-OES, PlasmaQuant PQ9000, Analytik Jena AG, Jena, Germany). XRD measurements of the powder feedstock were performed using a D8 ADVANCE diffractometer (Bruker AXS, Madison, Wis., USA) and using a Cu-Kα radiation source. Phase identification, reflection indexing, and estimation of the phase contents were made with the aid of TOPAS software, ver. 5 (Bruker AXS, Madison, Wis., USA).

LENS® Deposition Process

The 3D deposition experiments were performed using a commercial 750 LENS® system (Optomec, Inc., Albuquerque, N. Mex., USA). The system consists of a continuous wave (CW) fiber laser (IPG Photonics, Inc., Oxford, Mass., USA) with a maximum power of 1000 W at 1064 nanometer (nm) wavelength, a four-nozzle coaxial powder feed system, a controlled environment glove box, and a motion control system. Five block samples, with the dimensions of 60×15×15 millimeters (mm), were processed on an Al 5083 plate substrate. All samples were deposited according to the following sequence: the first three layers were deposited at laser power of 800 W, followed by 12 layers at laser power of 650 W, followed by decreasing the laser power to 600 W until the end of the designed geometry. The related zones in the printed alloy will be termed hereafter Zone 1, Zone 2, and Zone 3, respectively.

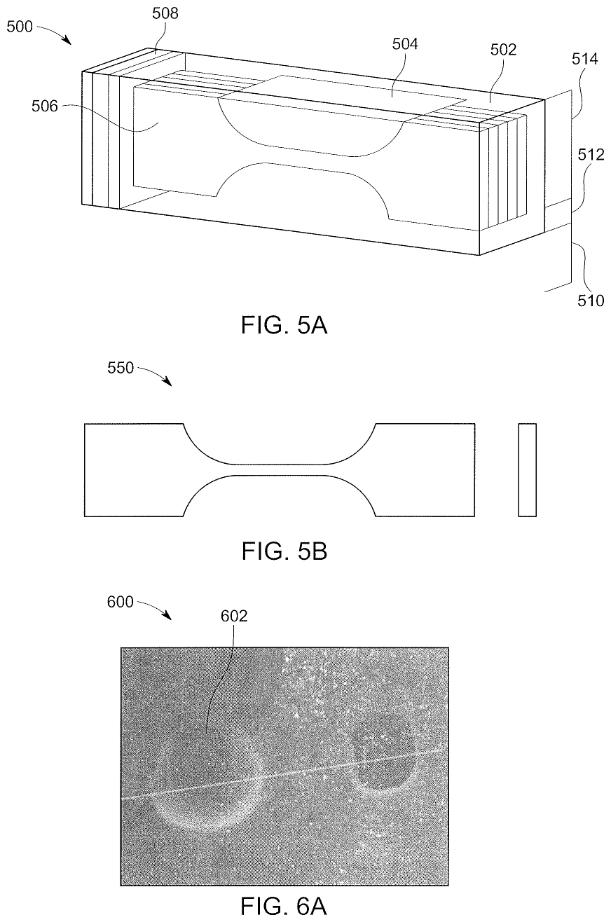

FIGS. 5A and 5B are schematic drawings illustrating a sample object 500 formed using the method 200 of FIG. 2. In particular, FIG. 5A illustrates from where on the object 500 samples for different characterization techniques were extracted along with the dimensions for the samples. A first region 502 illustrates an as-deposited sample. A second region 504 illustrates from where samples for chemical analyses and Archimedes density measurements were taken. A third region 506 shows from where Archimedes density measurements, μ-CT, tensile tests, and pulse-echo ultrasonic tests were taken. A fourth region illustrates from where EBSD, SEM, EDS, and XRD were taken. In addition, three zones 510, 512, 514 were deposited using different laser power values. In particular, Zone 1 510 was deposited using an 800 W laser, Zone 2 512 was deposited using a 650 W laser, and Zone 3 514 was deposited using a 600 W laser. FIG. 5B shows the graph 450 illustrating dimensions of a tensile test that was performed on the object 500.

The gradual decrease in the laser power was aimed to overcome relatively high back-reflection protection of the laser system and to allow surface temperature buildup that enables proper deposition. It should be noted that this study was mainly focused on the characterization of Zone 3, because Zones 1 and 2 are usually removed during disconnection of the printed or deposited object from the substrate. The thickness between successive layers was set at 0.254 mm, with a hatch spacing of 0.406 mm between adjacent deposits and a laser beam diameter of 0.5 mm. The laser energy density per unit area (I) was calculated using Equation (Eq) 1:

$$I = \frac{P}{v D} \qquad ( 1 )$$

where P is the laser power, v is the laser scan speed, and D is the laser beam diameter projected on the substrate. Depositing of the Al material was performed under an argon environment, keeping the oxygen level below 20 parts per million (ppm) to avoid oxidation during deposition. The initial oxygen level was 19.6 ppm; it decreased over time to 16.1 ppm. The rest of the processing parameters used in this study and relevant for Zone 3 are given in Table 1 below. Hereafter, LMF is defined as the low powder mass flow rate level, HMF is defined as the high powder mass flow rate level, LSS is defined as the low scan speed level, HSS is defined as the high scan speed level, and ML is defined as the middle level for both factors. The printing strategy was an angle of 90 degrees (90°) between the hatch lines of two adjacent layers.

TABLE 1
LENS ® powder mass flow rate, laser scan speed,
and laser energy density processing parameters
for Al 5xXX deposition. Laser power was 600 W in all cases.

| | Scan Speed | Mass Flow Rate | Energy Density |
|---|---|---|---|
| Sample | (mm/s) | (g/min) | (J/mm²) |
| LMF | 21 | 15 | 56 |
| ML | 21 | 25 | 56 |
| HMF | 21 | 33 | 56 |
| LSS | 17 | 25 | 70 |
| ML | 21 | 25 | 56 |
| HSS | 25 | 25 | 47 |

### 1. Sample Preparation For Microstructural and Mechanical Characterization

The three-dimensional deposited samples (15×15×60 mm, see FIG. 5A) were cut to cross-sections (fourth region 508 in FIG. 5A) and ground using 320 grit SiC paper, followed by polishing with diamond suspensions (9, 3, and 1 μm). Final polishing was done using 0.2 μm and 0.05 μm colloidal silica suspensions. For the microstructural investigation, the polished samples were chemically etched using Keller's reagent (2 mL HF, 3 mL HCl, 5 mL HNO₃, 190 mL DI water).

For mechanical properties investigation, tensile samples were fabricated (third region 506 in FIG. 5A) using a wire electrical discharge machining (EDM) system (FA20S, Mitsubishi Electric Corp., Tokyo, Japan). The dimensions of the tensile test samples are presented in FIG. 5B. The tensile sample geometry was validated by performing prior tensile tests of reference samples made of wrought Al 5083-0 combined with DIC analysis. All analyzed reference samples fractured within the gage and yielded mechanical property values in accordance with the requirements of the ISO-BS-EN 485-2:2016 standard.

Physical, Chemical and Microstructural Characterization

The bulk relative density of the deposited samples was measured according to the Archimedes principle using a BA 210 S balance with 0.1 mg readability and density determination kit (Sartorius AG, Göttingen, Germany). The samples were weighed in deionized (DI) water at room temperature. A surfactant was added to reduce their surface energy and allow full infiltration of water into any open pores or asperities at the surface of the sample. The calculated values were expressed as relative density (percentage), assuming that the density of fully dense Al 5083 is 2.66 grams per centimeter cubed (g/cm³). Comparison is made between the density values measured using the Archimedes method and those measured by μ-CT. μ-CT scans were made using an EasyTom system equipped with a 150 kV generator (RX Solutions, Chavanod, France). Pore diameter and pore sphericity were analyzed using a threshold algorithm implemented in the VGSTUDIO MAX CT software (Volume Graphics GmbH, Heidelberg, Germany). The microstructure of polished cross-sections was characterized by a light microscope (AX10, ZEISS, Oberkochen, Germany), SEM (Quanta 200 FEG, FEI, USA) equipped with an energy dispersive X-ray spectroscopy (EDS) silicon drift detector (X-Max SDD, Oxford Instruments, High Wycombe, UK) with 127 eV resolution and element analysis down to Boron, and EBSD detector (NORDLYS II, Oxford Instruments, High Wycombe, UK) with Aztec processing software. XRD (D8 ADVANCE diffractometer, Bruker AXS, Madison, Wis., USA) complemented the microstructure analysis. Chemical analysis of the printed material was conducted by a metal analysis OES spectrometer (Vario Lab, Belec Spektrometrie Opto-Elektronik GmbH, Georgsmarienhütte, Germany).

Mechanical Properties Characterization

To investigate the mechanical properties of the LENS® deposited Al 5xxx samples, Vickers microhardness testing was performed under 50 g load for 15 s, according to ASTM E384-17. Tensile tests were also performed. Tensile sample preparation included spraying black and white paint colors on the surface of the Al samples in order to achieve a randomly distributed speckles pattern with sufficient contrast for the DIC post-processing algorithm. The tensile tests were performed using an Instron 5582 machine equipped with a 50 kN load cell under a constant cross-head displacement rate of 0.1 mm/min. DIC data and post-processing were performed using DaVis 10 software package (LaVision GmbH, Gottingen, Germany). The sum of differential algorithm was used as a correlation technique for displacement tracking and strain calculation. In this method, the deformation of each image is defined as the sum of the differentials of the preceding images. This incremental method is recommended when analyzing elastic-plastic materials with high deformations. Two LaVision 5 MP, 12-bit CCD digital cameras were used: one equipped with a 105 mm Nikon HS-14 lens to view the full gage area, the other equipped with a ×12 magnification Navitar lens to view the middle-gage area in order to capture the axial and transverse strains, respectively. For both cameras, a light source was used to illuminate the surface of the specimen, and a recording frame rate of 2 Hz was used and synchronized with the Instron load data. The dual camera setup is necessary, in part, for determination of the Poisson's ratio.

There are issues affecting reliable modulus data from the static tensile test, such as misalignment and bending of the test specimen in the machine, the linearity of the stress-strain curve, the strain range over which the modulus fitted from the stress-strain data, the choice of procedures for carrying out data fitting, and high-temperature measurements. The accuracy of static methods depends on the precise measurement of small strain and linear elastic behaviors prior to yield. Inaccuracies in the slope fit can give significant errors in the values of the proof stress, particularly if the material has a high work-hardening rate in the early stages of yield. Dynamic methods have several advantages compared to static methods: (1) they are quick, simple, and non-destructive; (2) they use a small and simple specimen geometry, which may be beneficial if only small amounts of material are available; (3) it is possible to obtain the Young's modulus, shear modulus, and Poisson's ratio from a single test if an appropriate specimen geometry and setup are used; (4) they allow easier temperature control, and some can be readily modified to enable high-temperature measurements; (5) they facilitate avoiding creep under high stress; (6) brittle materials are easier to handle; and (7) they typically have better repeatability and higher precision because they do not depend on measurement of a small displacement. Typical errors in the measured values are as low as 1-2%. Dynamic methods also have some disadvantages: (1) the relevance of the dynamic modulus to engineering applications and design might be questioned; (2) they can be sensitive to machining damage, surface finish, and poor dimensional tolerances, all of which affect the accuracy of the result; (3) they do not always work well for some materials; (4) calculations require some knowledge of other material parameters; and (5) the test equipment is not as widely available.

Considering the above, the elastic constants were also measured using the dynamic pulse-echo ultrasonic non-destructive test (NDT) with a time-of-flight (TOF) sound velocity analysis. The “dynamically” measured Young's modulus and Poisson's ratio were compared to those obtained from tensile test in conjunction with DIC. The ultrasonic longitudinal and transverse wave propagation velocities through the specimen thickness (ν_{L} and ν_{T}, respectively) were thus measured.

The ultrasonic wave propagation velocity was first measured for a Krautkrämer's reference block made of steel (with a thickness d=2.556 mm), thus estimating the accuracy to be 1.3%. A standard 10 MHz probe was then used for ν_{L} measurements on printed specimens (d=1.79-2.31 mm). For the ν_{T} measurements, the test utilized used a 4 MHz normal incidence shear-wave transducer with high viscosity couplant. When sufficiently high frequencies are used so that the wavelength is small compared to specimen dimensions, the elastic constants of an elastic homogeneous material can be deduced using Equations 2-4 below:

$$\frac{G}{ρ} = {v}_{T}^{2} \qquad ( 2 )$$

$$\frac{E}{ρ} = {v}_{T}^{2} \frac{3 {v}_{L}^{2} - 4 {v}_{T}^{2}}{{v}_{L}^{2} - {v}_{T}^{2}} \qquad ( 3 )$$

$$v = \frac{{( {v}_{L} / {v}_{T} )}^{2} - 2}{2 [ {( {v}_{L} / {v}_{T} )}^{2} - 1 ]} \qquad ( 4 )$$

In Equations 2-4, G is the shear modulus, E is Young's modulus, ν is Poisson's ratio, and ρ is the density of the material (measured and matched individually for each specimen on which the ultrasonic velocities are measured).

Ultrasonic velocity measurements do not allow sufficient time for thermal diffusion. Thermal currents within the specimen cannot maintain constant temperature for the available frequency range, and direct contact with the surroundings is insufficient for isothermal conditions. Therefore, Young's modulus, as calculated from the ultrasonic velocities, is the adiabatic modulus (Ea), calculated in Equation 5, which is slightly higher than the isothermal Young's modulus (Eᵢ) obtained in a slow mechanical test:

$${E}_{a} = \frac{{E}_{i} ρ {C}_{P}}{ρ {C}_{P} - {E}_{i} {α}^{2} T} \qquad ( 5 )$$

where C_{P} is the specific heat at constant stress, a is the coefficient of thermal expansion (CTE), and T is the absolute temperature. At room temperature, and for metals that are characterized by relatively low CTE values, the difference between the adiabatic and isothermal elastic moduli is negligible.

2. Results

Chemical Composition of the Powder Feedstock Vs. The as-Deposited Alloy

To investigate the effect of the LENS® process parameters on the chemical composition, both the Al 5083 powder feedstock and the as-deposited Al alloy samples were characterized. The results are shown in Table 2 below. The chemical composition of the powder feedstock meets the standard requirements for Al 5083. However, as a result of reduction in the concentration of Mg (and Zn) in the as-deposited alloy, its chemical composition more closely matches the requirements for wrought Al 5754.

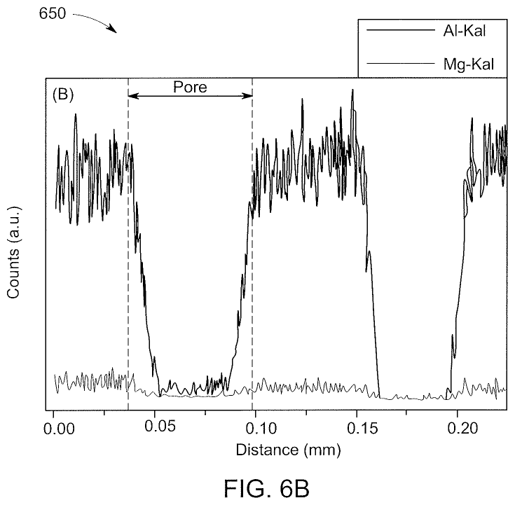

In order to examine the possibility that pores originated from the selective evaporation of Mg, EDS line-scan analysis was performed across random spherical pores in metallographic cross-sections. No noticeable accumulation of Mg at the pore surface was discovered (shown in FIG. 6, discussed below).

TABLE 2
Chemical composition (wt. %) of gas-atomized Al 5083 powder feedstock
and as-deposited Al 5xxx alloy. For comparison, the standard requirements
for wrought Al 5083 and Al 5754 alloys are also provided.

| Material | Mg | Mn | Cr | Si | Fe | Zn | Ti | Cu | Al |
|---|---|---|---|---|---|---|---|---|---|
| GA powder^{D} | 4.527 | 0.544 | 0.005 | 0 | 0.242 | 0.027 | 0.006 | 0.004 | Bal. |
| LSS^{F, G} | 2.743 | 0.477 | 0.051 | 0.262 | 0.230 | 0 | 0 | 0.002 | Bal. |
| HSS^{F, G} | 2.879 | 0.482 | 0.055 | 0.335 | 0.204 | 0 | 0 | 0.004 | Bal. |
| ML^{F, G} | 2.649 | 0.465 | 0.046 | 0.260 | 0.218 | 0 | 0 | 0 | Bal. |
| LMF^{F, G} | 2.861 | 0.459 | 0.043 | 0.249 | 0.207 | 0 | 0 | 0 | Bal. |
| HMF^{F, G} | 2.628 | 0.462 | 0.050 | 0.293 | 0.215 | 0 | 0 | 0 | Bal. |
| Al 5083^{C} | 4.0-4.9 | 0.40-1.0 | 0.05-0.25 | 0.40^{A} | 0.40^{A} | 0.25^{A} | 0.15^{A} | 0.10^{A} | Bal. |
| Al 5754^{C} | 2.6-3.6 | 0.50^{B} | 0.30^{B} | 0.40^{A} | 0.40^{A} | 0.20^{A} | 0.15^{A} | 0.10^{A} | Bal. |

^{A}Maximum value.
^{B}0.10-0.60 Mn + Cr.
^{C}Each other element: maximum 0.05 wt. %. Total other elements: maximum 0.15 wt. %.
^{D}ICP-OES.
^{E} OES.
^{F}See Table 1.
^{G}Mean values. The total concentration of other elements in these alloys was 0.113-0.116 wt. %.

FIG. 6A illustrates a SEM image 600 of pores in a cross-section of the formed object (500 of FIG. 5A). FIG. 6B illustrates an EDS line-scan 650 across a left, spherical pore 602 in FIG. 6A.

The Effect of Printing Conditions on Material Density and Porosity

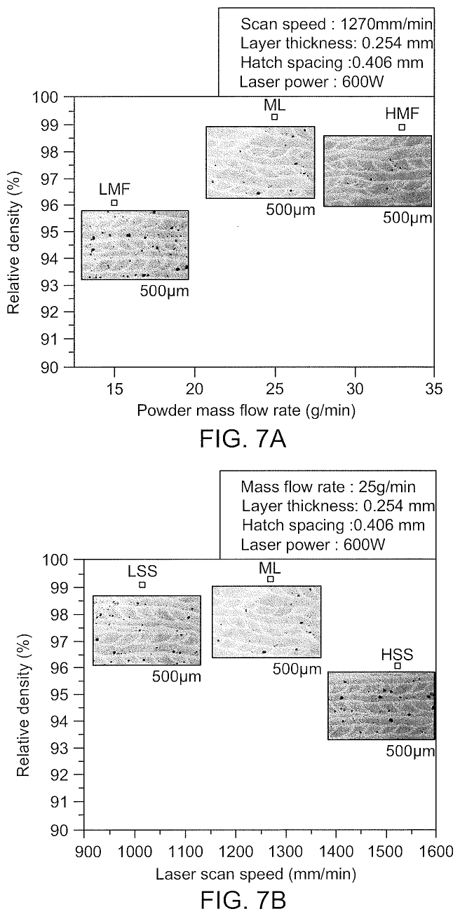

In this work, the inventors employed both the Archimedes method and μ-CT tests in order to measure the density of the deposited material. The mean relative densities of the as-deposited samples measured using the Archimedes method varied between 96.06% and 99.26%, depending strongly on the processing variables, such as powder mass flow rate (which is controlled by the argon flow rate) and laser scan speed (see FIGS. 7A, showing the effect of the mass flow rate of the powder on the relative density of the printed Al alloy; and FIG. 7B, showing the effect of the laser scan speed on the relative density of the printed Al alloy). Although the processing parameters still require additional optimization to achieve near full density, the observed process window shows that both the powder mass flow rate and the laser scan speed directly affect the deposited Al alloy density. The attained highest density was of sample ML, which is defined as the middle level in both investigations performed. On the other hand, the least dense samples were HSS (96.06%) and LMF (96.09%), which were processed with the highest laser scan speed and lowest energy density (HSS), or lowest powder mass flow rate (LMF). Furthermore, increased density was also observed in samples that were fabricated at high powder mass flow rate (or, high argon flow rate).

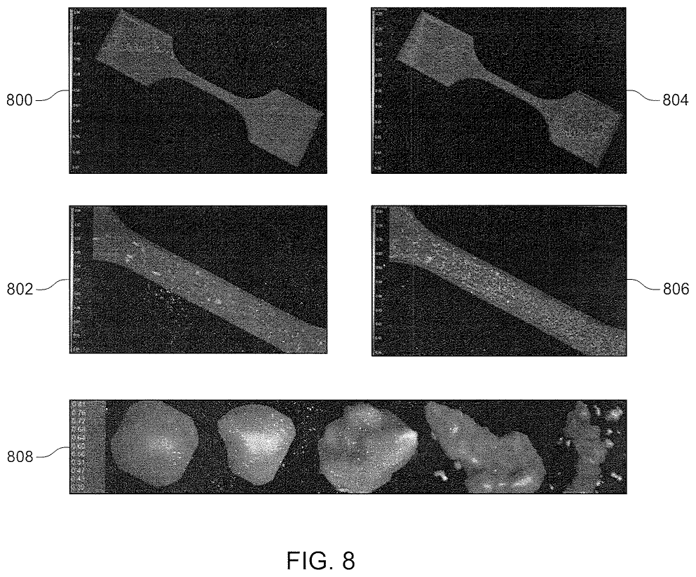

Porosity and density analysis was also done using μ-CT. A representative μ-CT illustration of pore diameter and pore sphericity in sample LSS is shown in FIG. 8. In particular, a first frame 800 shows pore diameters of pores of the formed object 500 of FIG. 5A. A second frame 802 illustrates a magnified view of the gage area in the first frame 800. A third frame 804 shows pre sphericity of the formed object. A fourth frame 806 shows a magnification of the gage area in the third frame 804. A fifth frame 808 shows selected representative types of sphericity morphology.

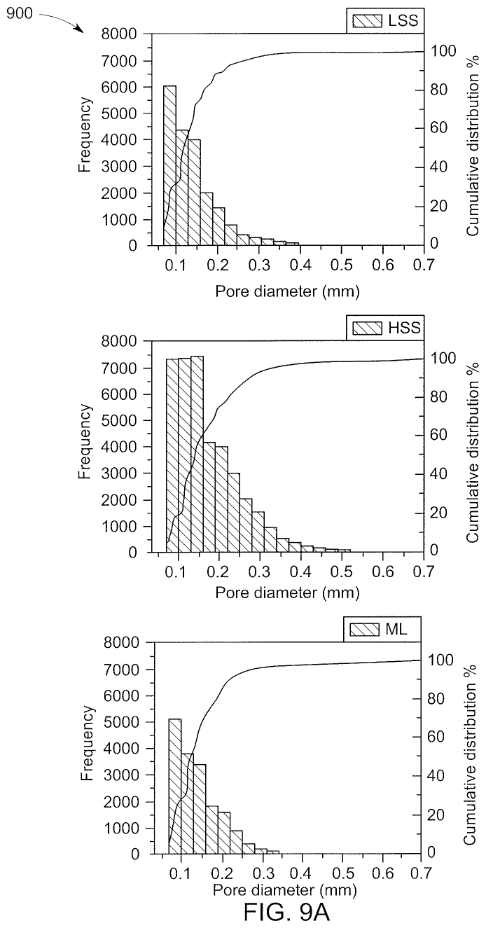

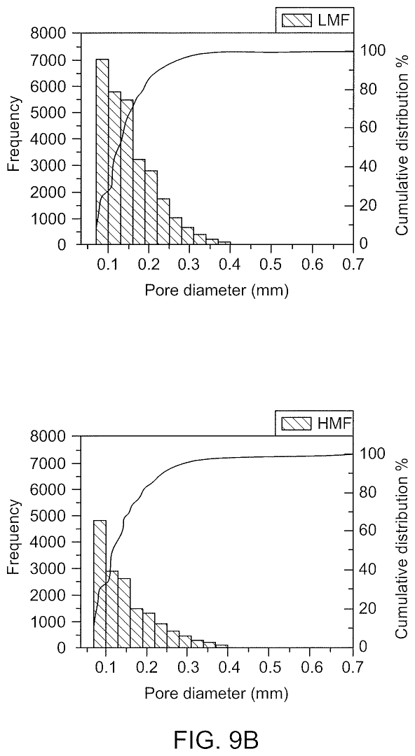

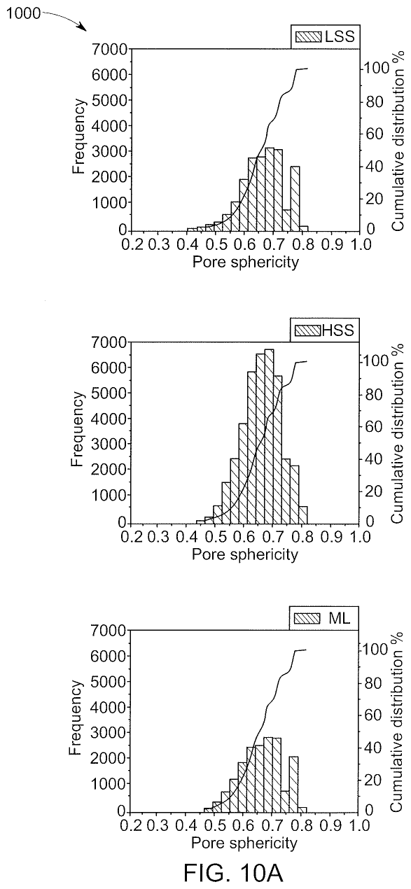

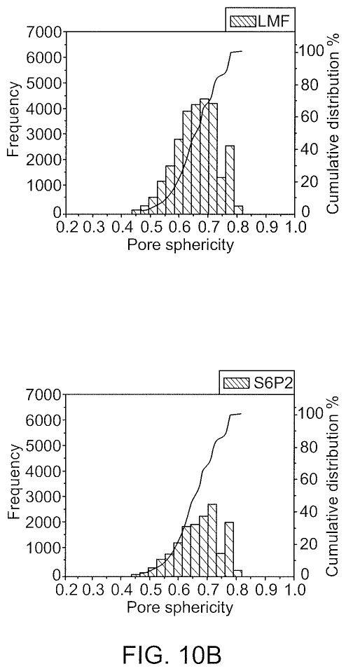

The pore size and pore sphericity population histograms with the corresponding cumulative distributions for different samples are presented in FIGS. 9 and 10, respectively. In particular, FIGS. 9A and 9B show histograms 900 illustrating pore diameter (X-axis) vs. frequency for the various samples. FIGS. 10A and 10B show histograms 1000 illustrating pore sphericity vs. frequency for the various samples. Spherical pores were observed scattered throughout the printed samples. Surprisingly, the μ-CT sphericity analysis indicated that the sphericity factor of the analyzed pores does not exceed 0.81 in any of the analyzed samples. Still, approximately 80% of the pores in all samples are characterized by a sphericity factor of 0.6 and higher.

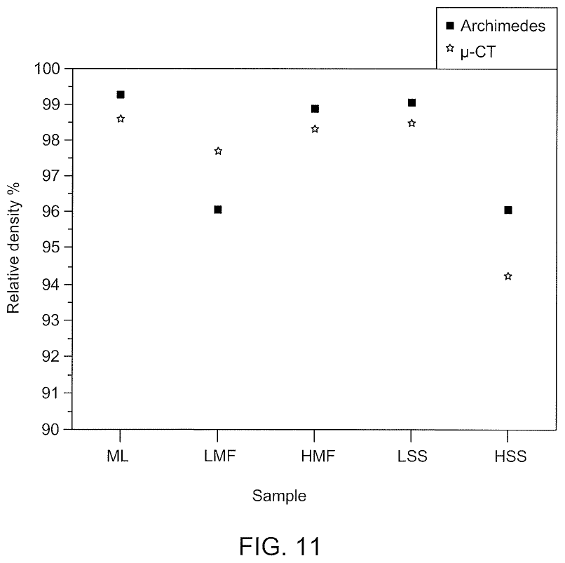

A summary of the relative densities analyzed utilizing both the Archimedes and μ-CT techniques is presented in FIG. 11. In particular, FIG. 11 is a plot 1100 illustrating a comparison between the mean relative densities of Al 5xxx printed samples obtained from the Archimedes and μ-CT techniques. Values obtained from μ-CT were found to be lower.

Microstructure Characterization

A light microscope composition image of a chemically etched cross-section of an as-deposited sample is shown in FIG. 12. A first frame 1200 shows a light microscope composition image of a cross-section of sample ML after chemical etching. A second frame 1202 shows a SEM enlarged image of a rectangular zone 1214 in the first frame 1200. A third frame 1204 shows a SEM enlarged image of a rectangular zone 1216 in the second frame 1202. A fourth frame 1206 shows a SEM enlarged image of a rectangular zone 1218 in the third frame 1204. A fifth frame 1208 shows a SEM enlarged image of a rectangular zone 1220 in the third frame 1204. A sixth frame 1210 shows a SEM enlarged image of a rectangular zone 1222 in the third frame 1204. A seventh frame 1212 shows a SEM enlarged image of a rectangular zone 1224 in the first frame 1200 revealing a keyhole defect due to partially-melted powder.

Zones 1, 2 and 3, defined in the section “LENS® deposition process,” are marked in FIG. 12. Some porosity is evident, in particular in the first printed layers adjacent to the base plate. A mesh-like morphology is noticeable throughout the entire deposit; it consists of horizontal and vertical curved thin interfaces that are light contrasted in the optical micrograph and dark contrasted in the SEM images (shown in the second frame 1202 and the third frame 1204). The vertical and horizontal interfaces correspond to the molten metal flow trails and inter-pass boundaries, respectively. The second frame 1202 and the third frame 1204 also reveal a continuous layer between every two adjacent layers with mesh-like morphology. This structure reflects the printing strategy of 90° rotation between the hatch lines of two adjacent layers. Consequently, in the microscope images, alternating longitudinal and transverse cross-sections of deposition tracks are observed. Importantly, the metal flow trails and inter-pass boundaries appear to be well fused throughout the deposited sample. This can be related to epitaxial interfaces. In addition, no evidence of hot cracking is observed in the sample. The fourth frame 1206 shows the microstructure at the inter-pass boundary. An inter-pass heat-affected zone (HAZ) from repetitive thermal heating during successive layer depositions is evident.

The fifth frame 1208 and the sixth frame 1210 reveal some difference in the microstructure in two distinct zones in a single solidification cell. In both zones, however, pores left behind a selectively etched (more chemically active) phase are evident. The exact identification of the selectively etched phase, which is surrounded by an α-Al matrix, has yet to be determined. However, given the chemical composition of this alloy, it can be speculated that this phase is rich in Mg. Its areal fraction in the fifth frame 1208 and the sixth frame 1210 is sufficiently great to expect it to be detectable by XRD, for example. As will be shown below, this is indeed the case. The seventh frame 1212 shows a magnification of rectangular area 1224 of the first frame 1200. A defect is noticeable, which illustrates porosity with irregular morphology related to lack of fusion where inclusions of un-melted particles are entrapped in between the unbounded surfaces.

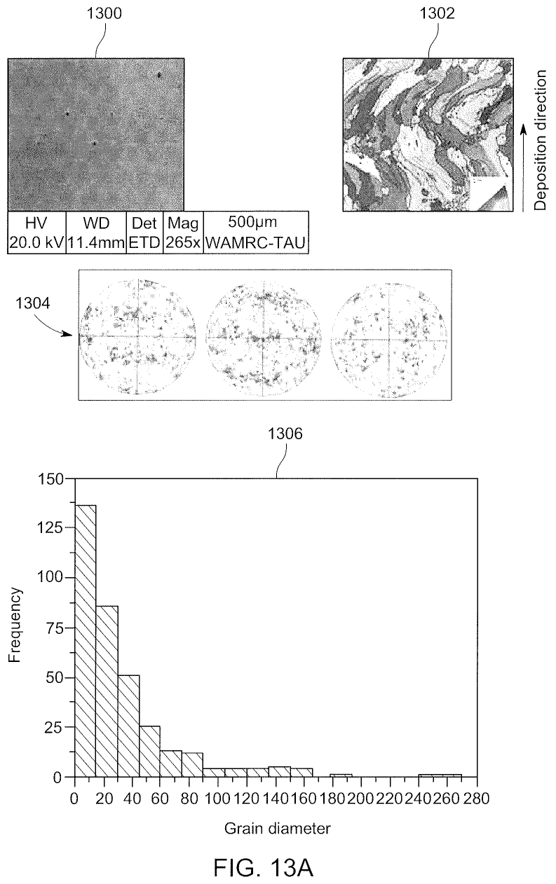

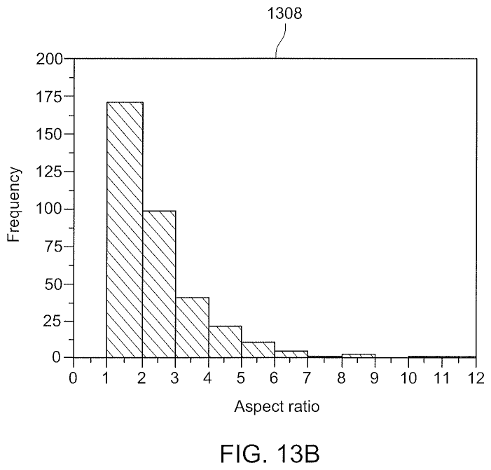

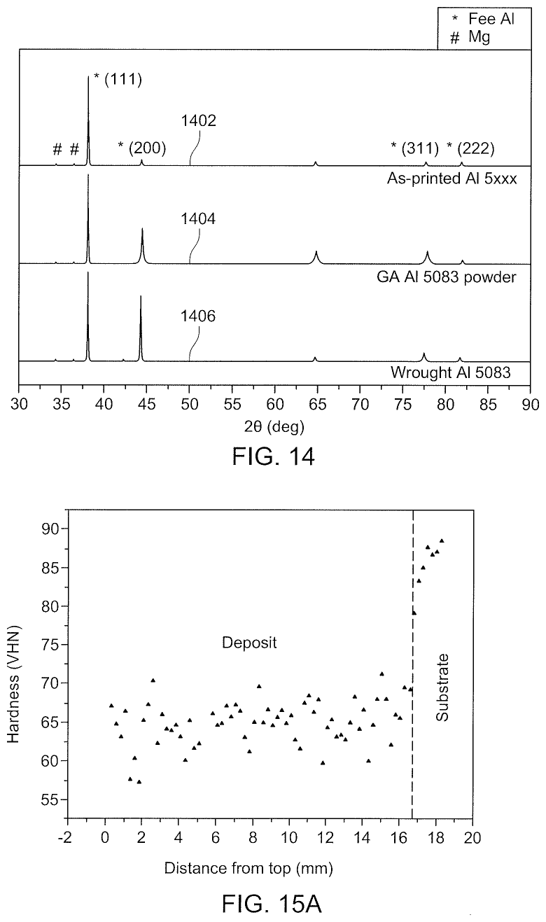

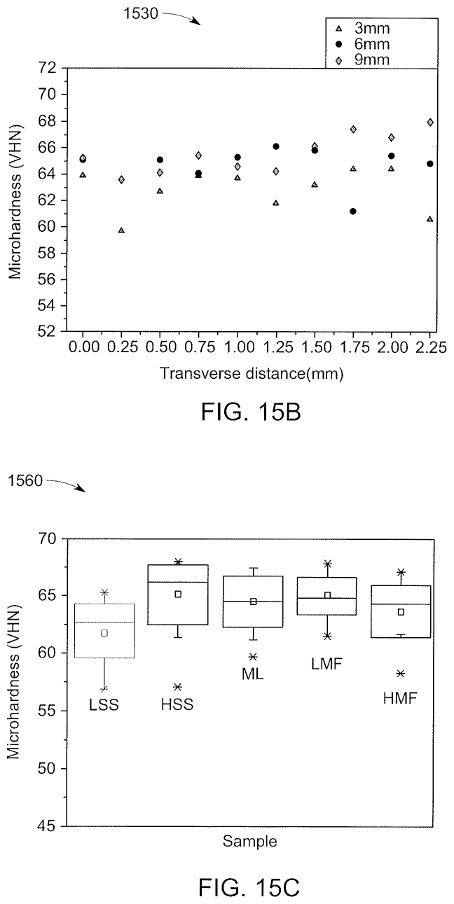

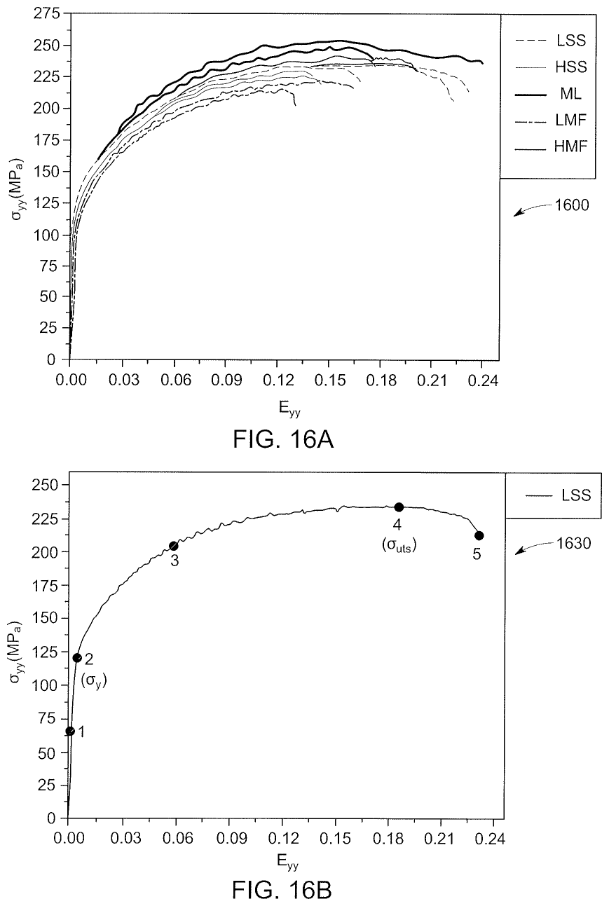

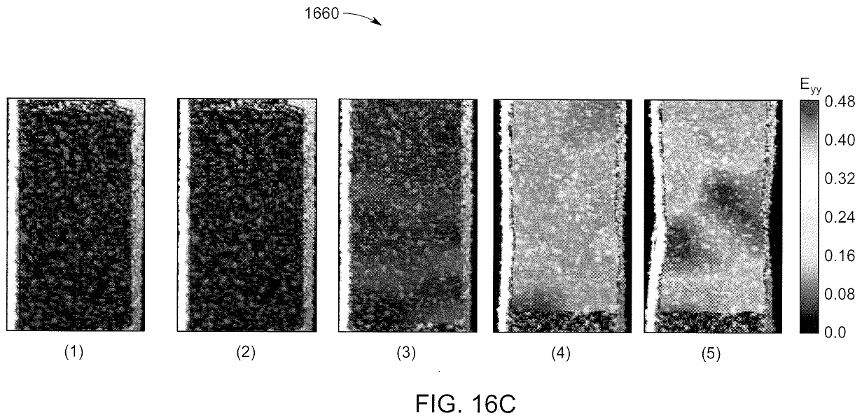

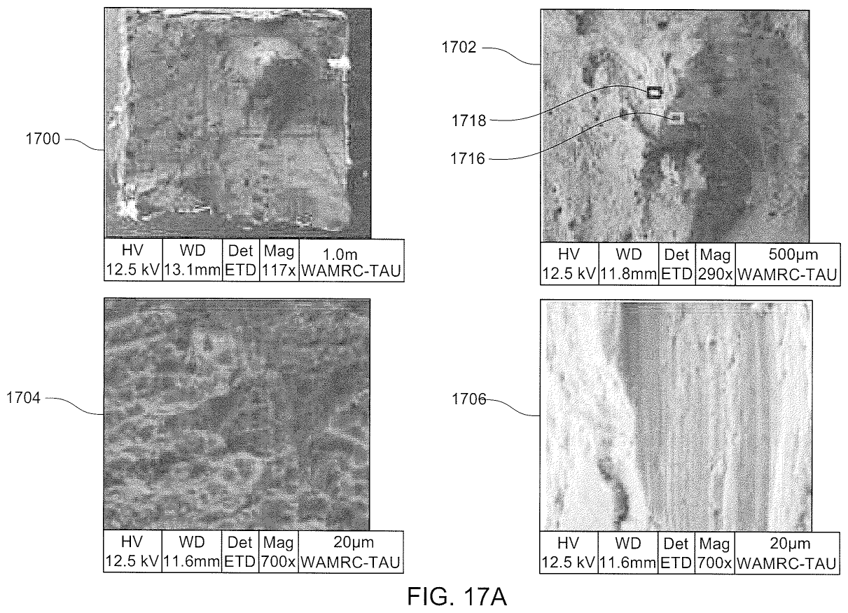

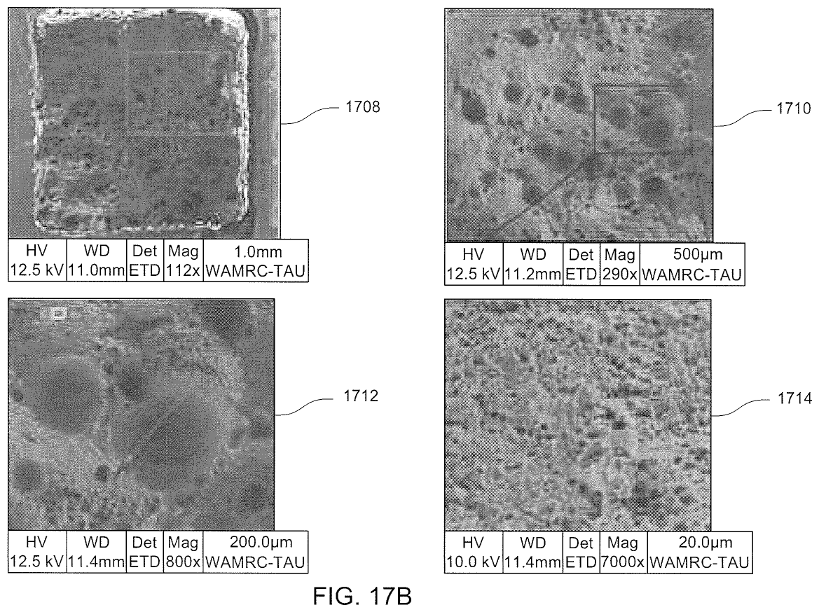

EBSD analysis was done to characterize the microstructure of the as-deposited alloy in terms of crystallographic orientation, grain size, and the grain morphology, and FIGS. 13A and 13B show various information related to the EBSD analysis. A first frame 1300 shows a SEM secondary electron image of a randomly selected area in the as-deposited sample ML. A second frame 1302 shows an EBSD orientation map of the first frame 1300, using the inverse pole figure coloring scheme. A set of spheres 1304 illustrates pole figures in principle orientations {111}, {101}, and {001}. A first histogram 1306 illustrates grain size distribution (n=357 grains). The numeric grain size is 36.0±2.1 μm. A second histogram 1308 illustrates a grain aspect ratio distribution (n=357 grains). The numeric aspect ratio is 2.52±0.08.

In particular, the second frame 1302 presents an orientation map of the analyzed cross-section shown in the first frame 1300 using inverse pole figure marking. This map is comprised of both equiaxed and columnar grains. Furthermore, epitaxial growth of the grains is evident, as the deposited layer grows with the same crystallographic orientation as its former. This results in columnar grains. In addition, a tilt growth angle can be observed. The pole figures 1304 show that in all principal orientations {111}, {101} and {001}, only relatively weak texture exists. This indicates a random grain orientation with no preferred crystallographic orientation. The grain size and aspect ratio distributions of the analyzed cross-section are presented in the histograms 1306, 1308.

XRD analysis was done to identify the phases in the as-deposited Al alloy (ML sample) and compare them to those in the as-received GA powder feedstock and in wrought Al 5083-0, and FIG. 14 illustrates a result of the XRD analysis. In particular, FIG. 14 is a plot 1400 that shows XRD patterns of the as-deposited Al alloy (of the sample ML, shown by a first line 1402), of the gas-atomized Al 5083 powder feedstock (shown by a second line 1404), and of wrought Al 5083-O (shown by a third line 1406). The Al 5083 sample was sectioned from the base plate on which printing was done, and standard annealing heat treatment was conducted prior to XRD analysis. TOPAS Rietveld refinement indicated (weighted profile R-factor, R_{wp}≅10.3) that the as-deposited alloy is comprised of 94.55 wt. % pure fcc Al (card #04-012-7848, lattice parameter α=4.0509 Å), 2.62 wt. % solid solution of Mg in Al (card #04-003-7061, Al0.9547Mg0.0453, fcc, a=4.0646 Å), and 2.83 wt. % pure Mg (card #00-035-0821, hcp, a=3.20936 Å, c=5.2112 Å). The only two reflections of the Mg phase evident in FIG. 14 are the two strongest reflections of this phase according to the card, namely (101) at 20=36.619° and (002) at 20=34.398°, which makes the identification of the phase based on only two reflections legitimate. The XRD-TOPAS analysis is consistent with the SEM characterization presented above, according to which the as-deposited alloy is comprised of a minor amount of Mg-rich phase surrounded by an Al matrix. The XRD results are also in good agreement with the EBSD analysis with respect to the crystallographic orientation. Finally, one could compare the chemical composition of the ML sample calculated based on the TOPAS analysis above to that measured by OES and reported in Table 2. The former is obtained by multiplying the concentration of phase i that contains element j by the concentration of the element in that phase, and then summing-up all relevant phases. Thus, it is estimated that the concentrations of Al and Mg in the as-deposited sample ML are 97.051 wt. % and 2.949 wt. %, respectively. The corresponding values obtained from OES are 96.362 wt. % and 2.649 wt. %, respectively. Thus, there is good agreement, in particular when recalling that the TOPAS analysis did not take into account any other element except Al and Mg.

Returning reference to FIG. 14, no significant difference is noticeable between the diffraction patterns of the GA powder, the as-deposited alloy, and the wrought Al 5083-0, except some intensification of the (111) reflection in the as-printed sample relative to the other reflections. A similar TOPAS analysis indicates (R_{wp}=9.24) that the GA powder is comprised of 54.84 wt. % pure Al, 42.33 wt. % solid solution of Mg in Al, and 2.83 wt. % pure Mg. This can be translated to an effective chemical composition of 95.252 wt. % Al and 4.748 wt. % Mg. The corresponding ICP-OES values in Table 2 are 94.645 and 4.527 wt. %, respectively. Thus, there is also good agreement of the TOPAS analysis of the feedstock powder and the ICP-OES data. This further validates the reliability of the TOPAS analysis. In addition, it shows that the selective evaporation of Mg in the LENS® process can be identified also by XRD.

Microhardness

Vickers microhardness values for the as-deposited ML sample are shown in FIGS. 15A, 15B, and 15C. FIG. 15A shows is a plot 1500 showing a discrete vertical line scan from the top of the deposited sample to the substrate. FIG. 15B is a plot 1530 showing discrete transverse line scans at various deposition heights (distance is given from the top of the sample). The measured Vickers microhardness values at distances of 3, 6, and 9 mm were 62.8±1.5, 65.3±2.2, and 65.5±1.4 VHN, respectively. FIG. 15C is a plot 1560 showing a summary of the hardness measurements of the as-deposited Al samples. The overall averaged microhardness of this sample is 64.6±3.6 VHN. No significant variation in hardness along the scan line is evident.

Tensile Test Combined with DIC Analysis

Uniaxial tensile tests combined with DIC analysis were carried out in order to determine the Young's modulus (E), Poisson's ratio (ν), yield stress (σ_{γ}), ultimate tensile strength (σ_{UTS}), fracture strain (ε_{f}), and total strain energy density/toughness (U_{T}) of the as-deposited alloy. These tests were complemented by a fractography analysis. The Young's modulus was determined by linear fitting of the longitudinal stress-strain curve, whereas Poisson's ratio was determined from transverse strain—longitudinal strain curves. Both were determined in the linear-elastic region (both, for data in the range of 250— 900με). The yield stress was determined at the 0.2% strain offset intersection with the stress-strain curve.

FIG. 16A is a plot 1600 illustrating engineering stress-strain curves of all as-deposited Al samples. FIG. 16B is a plot 1630 showing a representative stress-strain curve. The inset shows PLC serrations. FIG. 16C illustrates various DIC longitudinal strain-contour images 1630 corresponding to the numbered points along the stress-strain curve presented in FIG. 14B. A magnification of the dashed rectangular area is presented as inset. It illustrates the presence of Portevin-Le Chatelier (PLC) type-A serrations in the as-deposited Al alloy. DIC strain distribution contour images are presented in FIG. 16C. The numbers (1) through (5) correspond to the numbered points on the stress-strain curve in FIG. 16B. These images illustrate the tensile strain evolution in the direction of the applied load. It is observed that as the deformation develops, the local strain begins to increase gradually with no apparent necking at the sample's gage. At the ultimate tensile stress (point 4), necking of the sample starts to form, and localized strain concentration evolves. Point 5 illustrates the point where the fracture occurred, which indeed appears at the necking zone where the strains are maximal.

A summary of the values obtained from these tests is provided in Table 3 below. Although the samples were processed under different conditions of laser scan speed and powder mass flow rate, and consequently their density differs (see FIG. 7), their Poisson's ratio, yield strength, and the ultimate tensile stress values are similar. On the other hand, their fracture strain and toughness, two indicators of ductility, seem to be more sensitive to the level of porosity, namely the ductility decreases when the density is lower.

TABLE 3
Mechanical properties of printed samples based on tensile tests with DIC analysis.

| | E | σ_{y, DIC}^{A} | σ_{y, NDT}^{B} | σ_{UTS} | ε_{f} | | U_{T} |
|---|---|---|---|---|---|---|---|
| | (GPa) | (MPa) | (MPa) | (MPa) | (%) | υ | (J/mm³) |
| LSS | 62.0 ± 2.7 | 119.3 ± 2.5 | 117.4 ± 3.5 | 233.2 ± 3.5 | 18.9 ± 5.6 | 0.33 ± 0.06 | 39.7 ± 12.4 |
| HSS | 61.8 ± 3.9 | 115.0 ± 4.6 | 112.7 ± 4.0 | 226.0 ± 5.0 | 13.8 ± 2.7 | 0.32 ± 0.04 | 26.9 ± 6.2 |
| ML | 62.5 ± 1.3 | 121.4 ± 4.7 | 119.8 ± 4.7 | 244.3 ± 3.4 | 18.3 ± 1.0 | 0.32 ± 0.02 | 39.7 ± 2.1 |
| LMF | 63.0 ± 2.0 | 117.0 ± 3.0 | 116.6 ± 2.4 | 221.9 ± 3.3 | 14.8 ± 1.1 | 0.33 ± 0.03 | 38.9 ± 2.4 |
| HMF | 65.7 ± 2.5 | 121.0 ± 0.4 | 119.6 ± 2.0 | 239.0 ± 0.6 | 16.9 ± 4.0 | 0.34 ± 0.01 | 27.1 ± 2.7 |
| Wrought | 69-71 | min 80 | min 80 | 190-240 | min 16%^{C} | 0.33-0.34^{D} | — |
| Al 5754-O | | | | | | | |

^{A}Proof stress from the engineering stress-strain curve, using the value of E obtained from DIC.
^{B}Proof stress from the engineering stress-strain curve, using the value of E obtained from the ultrasonic dynamic test.
^{C}For specimen thickness 1.5-3.0 mm. The specimen thickness in this study was 2.0 mm.
^{D}CES EduPack 2018, Granta Design, Cambridge, UK.

Table 4 below summarizes the values of the Young's modulus, shear modulus, and Poisson's ratio deduced from pulse-echo ultrasonic tests. The rationale for conducting these tests was explained in the section “Mechanical properties characterization.” Calculations were per Equations 2-4. Comparing between the values of the Young's moduli in Tables 3 and 4, it is evident that the pulse-echo ultrasonic test consistently yields higher values than DIC, although they are still somewhat lower than the value typical of wrought Al 5754-O. This difference is responsible for the slightly lower σ_{γ} (proof stress) values reported in Table 3 based on the ultrasonic dynamic test compared to DIC.

The results in Table 4 show that the shear modulus values of all samples fall within the range typical of wrought Al 5754-O, while the values of the Poisson's ratio fall within the typical range, except in the case of the LMF sample where the value is somewhat lower than the typical one.

TABLE 4
Elastic constants of the printed alloy based on
the pulse-echo ultrasonic test.

| | E | G | |
|---|---|---|---|
| | (GPa) | (GPa) | υ |
| LSS | 68.1 | 25.5 | 0.337 |
| HSS | 66.6 | 25.1 | 0.330 |
| ML | 68.4 | 25.6 | 0.337 |
| LMF | 65.0 | 24.5 | 0.324 |
| HMF | 68.1 | 25.5 | 0.337 |
| Wrought Al 5754-0 | 69-71 | 23-27 | 0.33-0.34 |

Fracture Surface Morphology (Fractography)

Fractography was performed in order to characterize the fracture surfaces of the tensile specimens. The analysis was focused on the two samples that exhibited the maximal and minimal toughness in tension tests (LSS and HSS, respectively, see Table 3). Representative SEM images are shown in FIG. 17. In particular, FIG. 17 shows SEM-SE images of fracture surfaces after tension tests. A first four frames 1700, 1702, 1704, 1706 show sample LSS. A second four frames 1708, 1710, 1712, 1714 show sample HSS. The magnification gradually increases from top to bottom, with each called-out rectangle shown at higher magnification in the image below. Sample HSS is inherently more porous than sample LSS, in correspondence with the density values measured by the Archimedes method (see FIG. 11). Moreover, the majority of pores have a relatively spherical morphology. Macroscopically, the fracture surfaces of samples LSS and HSS are significantly different; LSS looks more brittle—it has a flatter surface, with macroscopically brittle features on the surface, and less pronounced shear lips. Microscopically, both fracture surfaces exhibit ductile characteristics, with fine overload dimples and apparent necking deformation. It should be emphasized that necking and fracture occurred within the gage section in all tensile specimens.

High-magnification fractography images reveal that in both samples, a small number of irregular pores is present. Frames 1702, 1704, and 1706 show two faces of a non-flat area of the fracture surface with two distinct surface morphologies. The first face (marked by a first rectangle 1716 in the frame 1702) is characterized by fine dimples, typical of ductile fracture (see the frame 1704). The second face (marked by a rectangle 1718 in the frame 1702), on the other hand, reveals cleavage facture morphology, which is typical of a more brittle fracture (see the frame 1706).

3. Discussion

Chemical Composition of the as-Deposited Alloy: Selective Evaporation of Magnesium

In section 3 it was shown that although Al 5083 powder feedstock was used, the chemical composition of the as-deposited alloy actually matches the requirements for wrought Al 5754 due to selective evaporation of Mg (and Zn) during DED. In section 1 it was conferred that selective evaporation of elements with low boiling point (high vapor pressure) such as Mg and Zn is one of the well-known challenges in processing of high-quality structural aluminum alloys by DED as well as by PBF and laser beam welding. This selective evaporation might result in fluctuation in alloy composition, voids, and gas porosity (and, therefore, reduction in material density), degradation of mechanical properties, and hot cracking.

Interestingly, the concentration of Mg in the as-deposited alloy may somehow depend on the powder mass flow rate. From Tables 1 and 2 it is evident that while the LMF, ML and HMF samples were printed under identical conditions of laser scan speed and energy density, as the powder mass flow rate (or, the Ar gas flow rate) is increased from 15 to 33 g/min—the concentration of Mg in the deposited alloy decreases from 2.861 to 2.628 wt. %. One possible explanation is that a higher gas flow rate results in a higher flux of oxygen feed gas impurity, which reacts with Mg in its oxidation process. If so, reducing the oxygen level in the build chamber to below 10 ppm (instead of 19.6-16.1 ppm used in this work) could be beneficial. It also could be that gas-dynamic phenomena are responsible for the effect of the powder/argon flow rate on the evaporation of Mg. Another plausible explanation is that increase in powder mass flow rate results in reduction of the melt-pool temperature, which in turn reduces the amount of Mg evaporation. This, however, requires further experimental study, and is beyond the scope of this paper and deserves further study.

Density Measurements: Archimedes and μ-CT Analysis

The mean relative densities of the as-deposited samples measured using the Archimedes method varied between 96.06% and 99.26%, depending strongly on the processing variables. This maximal value is high compared to typical densities of alloys processed by PBF (in their as-printed condition), for example, and may result in mechanical properties that are similar to wrought alloys than to cast alloys.

From FIGS. 7A, 7B, and 11 it seems that the material density decreases as the laser scan speed is increased (or, the laser energy density is decreased) and the powder mass flow rate (or, the Ar gas flow rate) is decreased. However, based on our preliminary design of experiments (DOE), not shown herein, for both factors a “process window” was found, namely, a parabolic fit with “apparent local maximum” in the range of the process parameters better describes the dependence than a linear line fit. In addition, FIGS. 7A and 7B each consists of only three points, thus no local optimum can be observed, at least not within the ranges of processing parameters that were used. Therefore, one cannot claim with high certainty for a decrease in density as the scan speed is increased of the powder mass flow rate is decreased. In general, a reduction in material density of samples that were fabricated at high laser scan speed could be related to the low laser energy density and the high surface reflectivity of the Al powder, which results in insufficient melting of the powder that interacted with the laser and the melt pool, and consequently—pore formation and related reduction in the observed density. On the other hand, the increase in material density of samples that were fabricated at high powder mass flow rate could be related to the low density of the feedstock Al powder and its poor flowability, which results in unstable powder mass flow rate. The powder mass flow rate is adjusted via the argon (carrier gas) flow rate. It should be noted that the highest density obtained was that of the ML sample, namely the sample that was deposited at middle levels for both factors (laser scan speed and powder mass flow rate). Hence, synergistic (or counter) effects of the processing parameters should be accounted for. Such effects may be revealed applying a thorough DOE methodology.

Several techniques are commonly used to measure the relative density and porosity of bulk materials, including AM alloys. These include the Archimedes method, μ-CT, gas pycnometry, and image analysis of metallographic cross-sections. The Archimedes method does not give any information on pore characteristics such as morphology, size, and distribution. In addition, density measurement by the Archimedes method can be influenced by surface roughness or open pores. In such cases, high surface tension of a sample does not allow the immersion fluid to completely immerse and infiltrate the analyzed sample, consequently resulting in increased density. FIG. 11 shows that the relative densities measured utilizing the Archimedes method are typically higher than those obtained from μ-CT. This difference can be explained by the inherent nature of μ-CT analysis. Porosity and sphericity analysis by μ-CT can be influenced by the X-ray beam scattering that has an effect on both the achieved resolution and image artifacts. In addition, the definition of image processing parameters, e.g. the threshold, can result in loss of information such as un-molten powder residues, thus possibly leading to inaccurate density values.

The Origins of Pores in the Deposited Alloy

Various mechanisms could contribute to porosity formation during laser deposition of Al alloys: (1) Selective evaporation of elements with high vapor pressure, such as Mg and Zn. (2) Poor powder flowability due to the low density of the Al powder along with low viscosity of molten Al. (3) An entrapped/dissolved gas that is present in the starting powder, which is subsequently released during DED. For example, moisture absorption in the Al powder and, consequently, hydrogen-related porosity due to the significantly lower solubility in the rapidly solidified metal. (4) Contamination by powder-feed gases. (5) Entrapment of gases by surface turbulence and gas entrainment during turbulent impact of particles into the melt pool. (6) The native oxide on the raw powder feedstock. (7) Shrinkage. (8) Collapse of unstable keyholes.

The porosity in the samples is evident in FIGS. 6A and 6B (SEM image of cross-section), 7A, 7B, and 12 (optical micrographs), 8-10 (μ-CT), and 17 (SEM image of a fracture surface). Spherical pores were observed scattered throughout the printed samples; given their morphology, they likely represent gas porosity. It was hypothesized that if the pores originated from the selective evaporation of Mg, then residual Mg should be present at the inner wall of the pores. However, EDS line-scan analysis across random spherical pores in metallographic cross-sections did not reveal accumulation of Mg at the pore surface (FIGS. 6A and 6B). Therefore, within the resolution constraints of the EDS line-scan measurements, it appears unlikely that the elemental evaporation of Mg was the principal cause of the observed porosity. From Table 1 and FIGS. 7A, 7B, and 11, it may seem that the material density increased as the powder mass flow rate (or, argon flow rate) was increased. If so, Ar gas entrapment during the rapid solidification is unlikely to be a principal cause of the observed porosity either. However, the reservations raised in the section “Density measurements: Archimedes and μ-CT analysis” should be borne in mind. On the other hand, due to the same effect of powder mass flow rate on the material density, the poor Al powder flowability may be one of the main contributors to porosity formation. In another study where porosity was found to increase with an increase in powder mass flow, it was argued that a higher powder density in the powder gas jet results in more hollow particles injected to the process, and therefore, a higher possibility of process gas entrapment in the process. In addition, the laser energy may efficiently melt all the powder injected. Yet, hydrogen gas precipitation may be a more significant contributor to porosity formation in this work. The source of this hydrogen could be either moisture absorption in the Al powder, which was not baked before DED, or contamination by the Ar powder-feed gas. Hydrogen concentration analysis, either of the bulk material or better locally around pores by techniques such as atom probe tomography (APT) or secondary ion mass spectrometry (SIMS), is still to be conducted in order to validate this hypothesis.

Porosity such as in FIG. 12, frame 1212 may be related to lack of fusion, where inclusions of un-melted particles are entrapped in between the unbounded surfaces. Such defects often originate from insufficient laser melting at the interlayer boundaries during processing. In addition, porosity due to lack of fusion may arise from rapid cooling and melt-pool instability due to the high thermal dissipation through the deposited aluminum alloy and the aluminum alloy substrate, or from the native oxide on the raw powder feedstock. Finally, the inherent porosity of the powder feedstock due to the gas atomization process may be responsible to some of the interlayer porosity in the as-deposited material.

The Microstructure of the as-Deposited Alloy

The microstructure of the as-deposited alloy is reflected from FIG. 12, frames 1202, 1204, 1206, 1208, 1210, and 1212 (SEM cross-section images), FIGS. 13A and 13B (EBSD analysis), and FIG. 14 (XRD patterns). The entire deposit consists of a mesh-like morphology, with an inter-pass HAZ from thermal heating during successive layer depositions. The metal flow trails and inter-pass boundaries appear to be well fused throughout the deposited sample. This can be related to epitaxial interfaces. No evidence of hot cracking is observed. Both equiaxed and columnar grains co-exist. This growth orientation is affected by the laser scan direction and is therefore related to the heat flux direction across the melt pool. This result is consistent with previous reports that showed a similar grain growth when using a similar printing strategy in DED. Rietveld refinement indicates that the as-deposited alloy is comprised of 94.55 wt. % pure fcc Al, 2.62 wt. % solid solution of Mg in Al, and 2.83 wt. % pure Mg. The XRD-TOPAS analysis is consistent with the SEM images, according to which the as-deposited alloy is comprised of a minor amount of Mg-rich phase surrounded by an Al matrix. Since pure Mg seems to exist already in the feedstock powder, its identification in the as-printed alloy excludes the option that its origin is selective evaporation and consolidation during the LENS® process. It should also be noted that in the Al—Mg phase diagram, no phase separation to either pure Al or pure Mg exists (namely, Al and Mg both have solid solutions in which the other element is dissolved). Therefore, the formation of both pure Al and pure Mg is a non-equilibrium process, or results from fast kinetics. The XRD results are also in good agreement with the EBSD analysis with respect to the crystallographic orientation. FIG. 12, frames 1208 and 1210 reveal some differences in the microstructure in two distinct zones in a single solidification cell, which can be explained by variations in the local cooling rates and heat dissipation during the solidification process.

Mechanical Behavior of the 3D Printed Aluminum Alloy

The mean value of the hardness of as-deposited Al alloy (FIGS. 15A, 15B, 15C) is substantially lower than the nominal Vickers microhardness of the Al 5083 substrate (83.7±2.6 VHN). This difference can be explained by the selective evaporation of Mg—the main strengthening element in this alloy—during the laser deposition process. As shown in Table 2 and discussed before, the chemical composition of the as-deposited alloy is most similar to that of wrought Al 5754. Yet, the hardness of the as-deposited alloy is slightly higher than that of Al 5754-O (52 BHN≅58 VHN). This is consistent with various reports showing that the refined grains resulting from the LENS® process result in increased microhardness.

Table 3 shows that all as-deposited samples have Young's modulus which is somewhat lower than that typical of wrought Al 5xxx alloys. This is likely due to the presence of porosity in the as-deposited samples. A correlation has been reported between the value of the Young's modulus and the level of porosity, and several theories and formulae have been suggested to describe this relationship. In spite of the porosity, the values of the yield strength, ultimate tensile strength, and elongation at break of the LSS and HMF samples all meet the requirements of the ISO-BS-EN 485-2:2016 standard from wrought Al 5754-O. There is a good agreement between the ductility values obtained from DIC analysis and the hardness results, namely, lower ductility corresponds to higher hardness, and vice versa. HMF has higher E value, while LSS has higher Ur value. Hence, the preference of one over the other with respect to mechanical properties would depend on the design criterion (rigidity vs. toughness). Further DOE for process optimization is likely to result in a material with reduced porosity and even better mechanical properties.

FIGS. 16A and 16B show PLC type-A serrations in the stress-strain curve of the as-deposited Al alloy. It is well known that both AM and wrought Al—Mg alloys (e.g. the 5xxx series, including Al 5754-O) often fail by plastic flow localization into narrow bands of intense shear. Instead of exhibiting the classic behavior of ductile fracture in the form of nucleation, growth and coalescence of voids, the failure mode is controlled by shear banding, with little evidence of damage prior to the final fracture event. The PLC effect increases the flow stress, ultimate tensile strength, and the work hardening rate, and decreases the ductility (both elongation and fracture toughness) of metals. The microscopic origin of the PLC effect is the dynamic strain aging (DSA) of the material due to interaction between solute atoms of Mg and mobile dislocations. In general, three types of PLC bands (A, B, and C) can be classified based on the type of serrations that appear in the stress-strain curve of polycrystalline materials during constant strain rate tensile tests. The appearance of the serrations changes from type A to type B and then to type C either with decreasing strain rate or increasing temperature. In the case of type-A serrations, the bands are narrow, continuously propagating, and highly correlated, and the associated stress drops are small in amplitude.

There seems to be good correspondence between the tensile test results (FIGS. 16A and 16B) and the microhardness results. Increase in hardness is usually associated with decrease in ductility, and vice versa. Here, sample LSS that has the highest ductility among all printed materials (see Table 3) also has the lowest microhardness (see FIG. 15C).

Comparing the values of density based on the Archimedes test (FIG. 11), the E values based on DIC (Table 3), and the values of E based on the ultrasonic test (Table 4), there is a one-to-one correlation between the order of density (or, porosity) values and the order of E values based on the ultrasonic test, which does not exist in the case of DIC-based E values. This is possibly because while ultrasonic test measures through-specimen properties whereas DIC monitors the outer surface of the specimen. This further supports a recommendation to use dynamic tests such as the pulse-echo ultrasonic test for measurement of the elastic constants of AM alloys, in addition to tensile tests combined with DIC. It should be noted that the tensile test specimens that were used were smaller than standard ones, and that the CCD digital cameras were 5 MP, 12-bit. Using larger samples with high-resolution cameras would probably increase the accuracy of the DIC analysis. It should be borne in mind that the “dynamic” wave measurements yield a total average of the wave speed over time (and, thus, space). In contrast, DIC is a full-field technique where the values extracted do depend on the spatial distribution and window size. It should also be noted that the presumably switched order of the E values of the LMF and HSS samples by ultrasonic test measurements is related to the use of thin samples for these measurements, which might not represent statistically the effective density of the sample. For example, the density values of the samples used for the ultrasonic tests were 2.637, 2.631, 2.629, 2.611, and 2.554 g/cm³ for the ML, LSS, HMF, HSS, and LMF samples, respectively. This problem, however, could easily be overcome by increasing the number of samples used for ultrasonic tests.

From FIG. 17 (SEM fractography) it is clear that sample HSS is inherently more porous than sample LSS, in correspondence with the density values measured by the Archimedes method (see FIG. 11). Moreover, the majority of pores have a relatively spherical morphology. This observation is consistent with the μ-CT sphericity analysis (see FIGS. 8 and 10 and related text). High-magnification fractography images reveal that in both samples, a small number of irregular pores is present, most likely due to lack of fusion between adjacent tracks during deposition. The fractography SEM images together with the mechanical properties reported above indicate that the inherent porosity may have a detrimental effect on the observed tensile properties. Future AM process optimization is still needed in order to improve the physical and mechanical properties.

The mixed type of fracture mechanisms evident in FIG. 17, frames 1702, 1704, and 1706, is frequently termed “quasi-cleavage.” This type of fracture can be explained by the nucleation and propagation of a crack through a critical lack of fusion defect along a cleavage plane of the neighboring grain. Propagation of the formed crack proceeds through neighboring grains across the as-deposited Al, until final fracture takes place.

Potential Applications and Further Alloy Modification

One could argue about what the benefit of additive manufacturing of an alloy such as Al 5754-O is. This last section is aimed at answering this question. Wrought Al 5754 has mid-strength, excellent corrosion resistance (especially to seawater and industrially polluted atmospheres), good weldability, very good burnishing and anodizing quality, and very good plasticity in its soft condition. One may argue that in the aircraft industry, the largest user of and investor in additive manufacturing, non-heat-treatable alloys such as Al 5754 are of less interest than heat-treatable alloys. While this is true, the potential markets for this alloy remain relatively large. Current applications of Al 5754 include shipbuilding, automobile manufacturing (in the sheet form, and at different temper conditions, it is the main material used to manufacture vehicle frames, seals, etc.), buses, railway and underground wagons, food processing equipment, welded chemical and nuclear structures, storage tanks, boiler-making, recipients for petrol, architecture and interior design, fishing industry equipment, treadplates, fridges, beverage cans, etc. Al 5754 has been widely used in sports cars and high-end cars like the Jaguar XK, Lotus Evora, Chevrolet Corvette, and BMW 7. A second argument could be that since aluminum alloys are relatively easy and cheap to process, and since DED may be limited in the geometric complexities that it can print, DED of an aluminum alloy such as Al 5754 may not be economically attractive. However, wrought Al 5754 suffers from some manufacturability limitations that may make manufacturing Al 5754 parts by DED attractive. For example, the high hot forming resistance of wrought Al 5754 allows only simple sections with greater wall thicknesses and no hollow sections using porthole dies. A third criticism could be that if the mechanical properties of a non-heat-treatable alloy in its as-printed conditions are similar to those of the wrought alloy in the annealed condition, and since post-printing work-hardening might be complicated, expensive, or even not possible, then it does not make sense to print such alloys. Furthermore, since its cutting tool suitability is low in the soft temper, and in order to increase its strength, the wrought material is often used in a work-hardened temper—mainly H22 (work-hardened by rolling and then annealed to ¼ hard). However, Al 5754 has many applications in the annealed condition. For example, in its plate form, Al 5754 is often used in the annealed temper. Furthermore, according to The Aluminum Association, Inc., “automotive structures are likely to employ increasing amounts of Al 5754-0 for parts such as internal door stiffeners or the entire body-in-white.”

Finally, a significant benefit of AM of Al 5754-O could be the ability to transform it relatively easily to a heat-treatable alloy with improved mechanical properties by minor alloying in the 3D printing stage. Addition of small quantities of scandium (Sc)—currently as low as 50 to 75 at. ppm—has been a common approach toward improving the strength and recrystallization resistance of 5xxx aluminum alloys. Upon aging, coherent nanometer-size Al3Sc precipitates form, with a high stability up to the melting temperature of Al. Zirconium (Zr) is added to improve the thermal stability of Al3Sc precipitates and to decrease the price of the alloying additions. Modified Al 5754 alloy with small quantities of Sc and Zr have shown higher tensile strengths than that of Sc- and Zr-free Al 5754-O alloy. Thus, an interesting future direction could be to add any one or more of Sc, Zr, erbium (Er), among others (including nickel (Ni), zinc (Zn), hafnium (Hf), lithium (Li), yttrium (Y), gadolinium (Gd), titanium (Ti), niobium (Nb), or oxygen (O)) to the Al 5083 powder that was used in this study, 3D print it with LENS® (which allows obtaining fine microstructures with enhanced mechanical properties; any other additive manufacturing process could be used in place of LENS®), and post heat-treat it (unless found unnecessary) to form fine precipitates, thus obtaining a modified Al 5754-O alloy with enhanced mechanical properties.

Where used throughout the specification and the claims, “at least one of A or B” includes “A” only, “B” only, or “A and B.” Exemplary embodiments of the methods/systems have been disclosed in an illustrative style. Accordingly, the terminology employed throughout should be read in a non-limiting manner. Although minor modifications to the teachings herein will occur to those well versed in the art, it shall be understood that what is intended to be circumscribed within the scope of the patent warranted hereon are all such embodiments that reasonably fall within the scope of the advancement to the art hereby contributed, and that that scope shall not be restricted, except in light of the appended claims and their equivalents.

What is claimed is:

1. A method for forming a 2-dimensional pattern or 3-dimensional object using an aluminum (Al) 5xxx series alloy, the method comprising:
providing a feedstock that includes the Al 5xxx alloy;
depositing, using an additive manufacturing process, the feedstock under thermal conditions that permit formation of the pattern or object; and
adjusting a parameter of the additive manufacturing process during the depositing.

2. The method of claim 1 wherein:
the Al 5xxx alloy is an aluminum-magnesium alloy; and
the amount of magnesium is 10 percentage by weight (wt. %) or less.

3. The method of claim 2 wherein the Al 5xxx alloy is includes at least one of Al5005, Al5010, Al5019, Al5024, Al5026, Al5050, Al5052, Al5056, Al5059, Al5083, Al5086, Al5154, Al5182, Al5252, Al5254, Al5356, Al5454, Al5456, Al5457, Al5557, Al5652, Al5657, Al5754, derivatives thereof, or combinations thereof.

4. The method of claim 3 wherein the Al 5xxx alloy includes Al 5754.

5. The method of claim 1 wherein the Al 5xxx alloy is enriched using elements excluding each of magnesium (Mg), chromium (Cr), manganese (Mn), and copper (Cu).

6. The method of claim 5 wherein the elements excluding Mg, Cr, Mn and Cu include at least one of scandium (Sc), zirconium (Zr), erbium (Er), nickel (Ni), zinc (Zn), hafnium (Hf), lithium (Li), yttrium (Y), gadolinium (Gd), titanium (Ti), niobium (Nb), or oxygen (O).

7. The method of claim 1 wherein the feedstock includes at least one of a wire, a powder, conglomerates, irregular particles, or variations thereof.

8. The method of claim 1 wherein providing the feedstock includes forming the feedstock using at least one of a gas atomization process, milling, grinding, machining, blending, water atomization, air atomization, a chemical process, or a physical process.

9. The method of claim 7 wherein the feedstock includes the powder and the powder includes particles having an average diameter that is 200 micrometers (0.00787 inches) or less.

10. The method of claim 1, wherein:
depositing the feedstock includes at least one of streaming, injecting, or feeding the feedstock using the additive manufacturing process; and
the parameter includes at least one of a laser power, a scan speed, a mass flow rate, a hatch spacing, a Z spacing, or an oxygen concentration in a deposition chamber.

11. The method of claim 10 wherein the laser power is 5 kilowatts (5 kW) or less.

12. The method of claim 10 wherein the scan speed is 100 millimeters per second (3.94 inches per second) or less.

13. The method of claim 10 wherein the mass flow rate is 150 grams per minute (5.29 ounces per minute) or less.

14. The method of claim 10 wherein at least one of the laser power, the scan speed, the mass flow rate, the hatch spacing, the Z spacing, or the oxygen concentration in the deposition chamber varies over time during the depositing the feedstock using the additive manufacturing process.

15. The method of claim 10 wherein depositing the feedstock includes setting at least one of the laser power, the scan speed, the mass flow rate, the hatch spacing, the Z spacing, or the oxygen concentration in the deposition chamber to a constant value and adjusting at least another of the at least one of the laser power, the scan speed, the mass flow rate, the hatch spacing, the Z spacing, or the oxygen concentration in the deposition chamber.

16. The method of claim 1 wherein depositing the feedstock includes depositing the feedstock onto a substrate.

17. The method of claim 16 wherein the substrate has a substrate surface is heated.

18. A method for forming a 2-dimensional pattern or 3-dimensional object using an aluminum (Al) 5xxx series alloy, the method comprising:
providing a feedstock that includes the Al 5xxx alloy; and
depositing, using an additive manufacturing process, the feedstock under thermal conditions that permit formation of the pattern or object, the additive manufacturing process having adjustable parameters that include at least one of a laser power, a scan speed, a mass flow rate, a hatch spacing, a Z spacing, or an oxygen concentration in a deposition chamber, and at least one of the adjustable parameters varying over time during the depositing the feedstock to facilitate the formation of the pattern or object.

19. The method of claim 18 wherein at least one of the adjustable parameters is set to a constant value during the depositing the feedstock.

20. A system for forming a 2-dimensional pattern or 3-dimensional object using an aluminum (Al) 5xxx series alloy, the system comprising:
a feedstock that includes the Al 5xxx alloy; and
an additive manufacturing machine configured to deposit and melt the feedstock at parameters that include a laser power, a scan speed, a mass flow rate, a hatch spacing, a Z spacing, and an oxygen concentration in a deposition chamber, at least one of the laser power, the scan speed, the mass flow rate, the hatch spacing, the Z spacing, or the oxygen concentration in the deposition chamber varying over time to facilitate formation of the pattern or object.
